(19) United States
(12) Patent Application Publication
(10) Pub. No.: US 2018/0230033 A1
(43) Pub. Date: Aug. 16, 2018

(54) RAPID STARTUP OF FACILITIES AND REMOVAL OF ORGANICS AND NUTRIENTS FROM WASTEWATER

(71) Applicant: William E. Cumbie, Yorktown, VA (US)

(72) Inventor: William E. Cumbie, Yorktown, VA (US)

(21) Appl. No.: 15/143,977

(22) Filed: May 2, 2016

(51) Int. Cl. C02F 3/30; C02F 3/28; C02F 3/32; C02F 3/34; C02F 3/00; C02F 3/10

(52) U.S. Cl. CPC C02F 3/307; C02F 3/2806; C02F 3/2853; C02F 3/2866; C02F 2003/001; C02F 3/325; C02F 3/348; C02F 3/006; C02F 3/105; C02F 3/301

(57) ABSTRACT

This invention is to the removal of organics and nutrients from wastewater. More specifically, the invention addresses the removal of nutrients such as nitrogen and/or phosphorus from wastewater and has specific adaptations that can be of added benefit in small systems including septic tanks, cluster wastewater systems, and other small treatment plants. The invention can also be used for larger treatment works and for sidestream treatment systems. The invention also has adaptations that can be used to treat wastewater in low gravity and other difficult environments. The invention also has adaptations to permit rapid startup, to induce dormancy, and to preserve organisms for extended periods of time.

### CROSS-REFERENCE TO RELATED APPLICATIONS

THIS PATENT CLAIMS PRIORITY OF PPA 65/156,221 FILED MAY 2, 2015, PPA 65/159,870 FILED MAY 11, 2015, AND PPA 62/262,660 FILED DEC. 3, 2015

### FEDERALLY SPONSORED RESEARCH: NONE

### SEQUENCE LISTING: NONE

### 1 BACKGROUND—FIELD OF INVENTION

This invention relates to the removal of organics and nutrients from wastewater. More specifically this invention addresses the removal of nutrients such as nitrogen and/or phosphorus from wastewater and has specific adaptations that can be of added benefit in small systems including septic tanks, cluster wastewater systems, and other small treatment plants. The invention can also be used for larger treatment works and for sidestream treatment systems. The invention also has adaptations that can be used to treat wastewater in low gravity and other difficult environments. The invention also has adaptations to permit rapid startup, to induce dormancy, and to preserve organisms for extended periods of time.

### 2 BACKGROUND OF THE INVENTION

Wastewater treatment has progressed significantly over the past two centuries. In the 1800's wastewater treatment often consisted of collection and disposal of wastewater in a sanitary manner. Some treatment was provided at times and consisted of screening of large material and removal of settleable solids. This level of treatment is today termed preliminary treatment (screening larger items and settling inorganics such as sand and grit) and primary treatment (settling of organic matter). The 1900's saw the introduction of biological treatment (activated sludge, trickling filters, etc.) to removed dissolved organics and this type of treatment was termed ‘secondary treatment’. In the 1970's ‘tertiary treatment’ began to be provided at time and generally consisted of nutrient (nitrogen and phosphorus) removal, though at time additional filtration of fine particles was also undertaken at times. Relative costs for primary, secondary, and tertiary treatment are on the order of 3× to upgrade from primary to secondary and 2× more to upgrade to tertiary (total 6×) respectively for municipal plants. This is an approximation but it indicates the large differences in costs for various levels of treatment.

Smaller treatment works have been even slower to upgrade treatment systems due to both high costs and generally more limited funds. Additionally, many treatment systems consist of septic tanks and drain fields that serve single homes. Approximately one-third of the U.S. population is served by 20 million septic tanks and drain fields; which for the most part provide only primary treatment in the tanks and partial secondary treatment as the effluent percolates through the (biologically active) soil of the drain fields. A very small number of single home systems provide full secondary treatment and an even smaller number remove nitrogen. Removal of nitrogen from septic tanks has become a big issue and several states such as Maryland have enacted legislation to address this issue. To date, the cost of systems to remove nitrogen from septic tank effluents has remained high. Likewise, the cost to remove nutrients from wastewater system, particularly small ones, remains too high for many to afford.

There exists a need to economically remove nutrients from wastewater and more particularly there is great need to develop an economical, reliable, and robust treatment system that requires minimal attention and is capable of removing nitrogen from the effluent from septic tanks.

There is an additional need for a method and system to rapidly start a treatment system. This can be very helpful for temporary facilities, emergency response, and restarting a failed or failing existing system.

### 3 BACKGROUND OF INVENTION—OBJECTS AND ADVANTAGES

This invention combines elements that are related but independent of one another to form a composite unit that has additional advantages and benefits compared to the individual elements separately.

### 3.1 Objects and Advantages of Concurrent Nitrification/Denitrification/Deammonification (NDD) Treatment.

Wastewater treatment generally accelerates and augments degradation of pollutants more than a thousand-fold compared to natural processes. This is accomplished by sustaining a high concentration of organisms in tanks and providing means to enhance the degradation of matter. The cost of tankage and the pumping that is required is a major cost of wastewater treatment.

To date no one has successfully be able to concurrently nitrify, denitrify, and deammoniate wastewater since some of these organisms require free oxygen for proper operation while others cannot function properly if free oxygen is present. This invention provides for nitrification/denitrification/deammonification (NDD) in a single tank, thus greatly reducing the cost and complexity of treatment.

Organisms that require oxygen are termed aerobic while those that cannot function properly when free oxygen is present are termed anoxic or anaerobic organism. While the terms anoxic and anaerobic are often used interchangeably in biology, sanitary engineers generally use the term anoxic to refer to an environment that has no free oxygen but has bound oxygen in the form of nitrate, nitrite, and other molecules that have oxygen while anaerobic is used to refer to an environment where there is no free or bound oxygen present. Using this definition, most denitrifiers and anammox organisms are anoxic; that is they can exist and function properly when there is no free oxygen but there is combined oxygen in the form of nitrites and nitrates.

NDD can be used to concurrently remove both organic carbon and nitrogen. The operation of an NDD treatment system can be tailored to permit denitrification for removal of a substantial amount of organic carbon with removal of ammonia and the used of anammox to remove a substantial amount of the remaining amount of ammonia without the need for organic carbon. Since NDD can thus be used to remove both organic carbon and nitrogen in a single unit process using the least amount of energy of competing processes, it is the most economical method to remove a substantial amount of organic carbon and nitrogen.

### 3.2 Objects and Advantages of Patterned Fixed-Film Treatment (PFT)

Wastewater treatment utilizes a wide range of environments to remove organics and nutrients. Often conditions within a treatment system have significant spatial variation even in a single tank. The level of nutrients, dissolved oxygen, mixing intensity, etc. can vary horizontally and vertically often by an order of magnitude or more. Patterned Fixed-film Treatment (PFT) reduces these variations and establishes a less variable profile. The advantages of PFT include the ability to optimize the biome of organisms and the treatment of wastewater. Other forms of treatment such attached growth media that is mixed in a tank have varying conditions including abrasion of biomes due to collisions of the media as they mix. This shears off biofilm which can be detrimental to treatment. The media also move through different parts of the tank and are exposed to different oxygen and nutrient levels. PFT advantageously reduces these conditions and permits a higher level of treatment to occur. It also advantageously maximizes the use of space.

PFT can make use of anchored scaffolds to achieve relatively consistent treatment. These scaffolds can keep the biofilm in a set location and can be combined with complete mixing of the tank to homogenize the environment. Additionally, anchored scaffolds can be coupled with multiple addition locations to create relatively consistent treatment. PFT also permits the conditions of a particular portion of the tank to be varied to address a particular issue in that area. For example, if one area had excessive biofilm growth, a localized backwash sequence could be initiated to restore the area to the condition of adjacent areas.

PFT can also make use of anchored fixed-film scaffolds that accommodate high concentrations for organisms. Conditions in PFT can be arranged to permit attached organisms to outcompete suspended organisms thus greatly reducing the level of suspended solids which in turn simplifies solids retention and makes effluent filtration much easier.

### 3.3 Objects and Advantages for Variable Submerged Treatment (VST)

Another set of object and advantages of the invention are the improved control of wastewater treatment by use of variable submerged treatment (VST). VST permits the liquid level to be varied enable the fixed film portion of treatment to have varying exposure to both liquid and gas phases. VST can be used in a more steady-state mode for treatment or the level can be varied dynamically. Steady state mode can be more useful to maintain fairly static environmental conditions while dynamic VST can be used to cycle through various phases of treatment such anaerobic and anoxic phases.

Dynamic VST can is also well suited for combined use with a patterned fixed-film treatment (PFT) system. PFT retains fixed-film scaffolds in a relatively stable location thus permitting better control of the microenvironment since the scaffolds do you move freely and do not pass in and out of varying conditions such as aerobic/anaerobic or high food/low food areas.

### 3.4 Objects and Advantages for Septic Tanks and Other Treatment Systems

Two elements of the invention that can be combined synergistically are, 1) a conditioning element that adjusts, conditions, and regulates the wastewater to be treated and, 2) a treatment element that beneficially removes and/or transforms wastewater components that could damage the environment. In particular, the conditioning element can perform some or all of four roles including, 1) adjusts the characteristics of the wastewater such as pH, temp, etc., 2) buffers undesirable spikes of elements such as high levels of ammonia, nitrite, etc., 3) provides slow release of food for organisms during times of low influent flows, and, 4) can provide necessary micronutrients to help ensure effective treatment. These two elements are delineated separately in this discussion; however, they can be combined into one unit and worked in tandem concurrently if that is advantageous. Several additional elements that can be part of the system are a connection element, a clarification element, and an instrumentation and control element. These are also elucidated in this text.

Although large treatment plants are able to condition wastewater as it passes through the plants various unit processes, smaller plants cannot generally afford to address this element. In particular, septic tanks make no provision for conditioning of the wastewater beyond minimal flow dampening and storage of biosolids for subsequent disposal.

While there is no provision for conditioning elements in septic tanks there is ironically an unobvious but greater need for this type of conditioning for small systems such as septic tanks than there is for larger systems. For example, a septic tank may be sized to receive one home's wastewater. Therefore, any full strength pollutant enters full strength and is not diluted by others wastewater. An individual residence may have high concentrations of a certain item (for example, during clothes washing a high level of detergents may be released) for a short period which could adversely impact treatment. In larger systems such constituents are diluted by other flows and their impact is mitigated. High concentrations of certain wastewater constituents could be highly detrimental to biological activity in the septic tank. Thus, though it is not obvious, there is a greater need to buffer smaller systems than larger systems since they can have relatively higher spikes of problem constituents than large systems have.

Another reason conditioning systems are desirable for septic tanks is that these tanks are generally not serviced frequently. Thus, while the ‘out of sight, out of mind’ syndrome argues not to worry about small systems, in reality these systems require special care since they must function independently for long periods of time. Again, though it is not obvious such conditioning is necessary, it is very important for small systems to be protected against high concentrations of harmful constituents. To date, there has been no simple, robust operating system that can both concurrently nitrify, denitrify, and deammoniate with minimal attention. Such a system is greatly needed since this is the most efficient way to remove nitrogen from wastewater.

Additionally, some microorganisms are irreversibly damaged by high levels of undesirable constituents. For example, though anammox organisms use nitrite as an energy source, high levels of nitrite can irreversibly damage their ability to remove nitrogen from the system. Similarly, anammox organisms can have increased sensitivity to nitrite spikes if the pH is depressed below 7, therefore, buffering of wastewater to maintain an optimal pH is necessary to ensure optimal treatment by bacteria. In like manner, high pH wastewater that has significant free ammonia can also adversely affect anammox.

Accordingly, with regard to the first element of this invention (conditioning element), we propose an element that that performs some or all of four roles including, 1) adjusts the characteristics of the wastewater (such as pH, temp, etc.), 2) buffers undesirable spikes of elements (such as high levels of ammonia, nitrite, etc.), 3) provides slow release of food for organisms during times of low influent flows, and, 4) can provide necessary micronutrients to help ensure effective treatment.

With regard to the second element of this invention (treatment element), septic tanks have not used anammox organisms for removal of nitrogen because the organisms generally require careful monitoring and control to ensure they perform optimally. If they are damaged by adverse conditions, such as high nitrite or free ammonia levels, they may not recover and treatment will be stopped. However, if method(s) and/or device(s) are used to identify and/or prevent adverse conditions from arising then anammox may be a viable treatment mode if other obstacles are overcome. Some of the additional obstacles that must be addressed are, 1) the slow growth rate of organisms, 2) the need for additional organisms to effect treatment (i.e. nitrifiers), 3) the need to maintain a proper mix of organisms, 4) creation of the proper environment that includes both aerobic and anoxic conditions, and, 5) creation of an environment that can accommodate fluctuations in flow and constituents. Accordingly, with regard to the second element of this invention (treatment element), we propose an element that that performs some or all of five roles noted above.

Accordingly, this invention has a number of objects and advantages including the following:
1. Can provide superior treatment of wastewater, including the removal of nutrients:

Use of specialized bacteria can achieve high levels of treatment in limited space

Removal of nitrogen without the need to add supplemental carbon

Lower energy requirements compared to conventional nutrient removal technologies

Capable of withstanding fluctuations in the quality and quantity of wastewater
2. Additional advantages include:

Ability to be added to existing septic tank systems to improve performance

Easier, quicker, and safer installation

Lower cost installation and maintenance

Better for environment due to higher removal of pollutants

The invention provides a low cost, reliable solution that permits small treatment units to upgrade their ability to treat wastewater and remove nutrients. This invention also permits the installation of this technology as an add-on, or retrofit, as well as being incorporated into an overall new treatment system.

### 3.5 Objects and Advantages for Completely Integrated Wastewater Treatment System

NDD can be integrated into a complete, compact wastewater system that is capable of beneficially recovering energy in the form of methane and electricity and nutrients in the form of nitrogen and/or phosphorus compounds.

### 3.6 Objects and Advantages for Retrofit of Systems

Another set of object and advantages of the invention are the improved wastewater treatment at plants and the ability to retrofit this into existing plants. This is particularly simple when a prefabricated PFT system is designed to fit in an existing basin. Attached integrated fixed-film activated sludge (IFAS) can also be used with this invention's specified organism mix and other new items to achieve nutrient removal.

### 3.7 Objects and Advantages for Compact Treatment

Another set of object and advantages of the invention is a compact treatment system which is particularly useful for mobile units or places where space is at a premium. A very compact arrangement is particularly possible by varying membranes and biofilm scaffolds that are in close relation to one another. Additionally, if the membranes alternately feed gasses such as oxygen to the reactor and withdraw effluent then additional compactness can be achieved.

### 3.8 Objects and Advantages for a Method and Means to Preserve, Store, and Reactivate Organisms and Other Substances

Another set of object and advantages of the invention is the ability to rapidly start a treatment system which is particularly helpful for emergency response, temporary facilities, and restarting a system that has failed or is performing poorly. This is also useful to introduce specific organisms for treatment.

### 3.9 Objects and Advantages for a Complete, Prefabricated Treatment System

Another set of object and advantages of the invention is a compact treatment system which is particularly useful for mobile units or places where space is at a premium. A very compact arrangement is particularly possible by varying membranes and biofilm scaffolds that are in close relation to one another. Additionally, if the membranes alternately feed gasses such as oxygen to the reactor and withdraw effluent then additional compactness can be achieved.

### 3.10 Objects and Advantages for Floating Treatment Structure (FTS)

Another set of objects and advantages of the invention is the use of a treatment structure to facilitate treatment. This structure can provide a location for biomes for organisms which in turn can provide treatment. The structure could be located in or adjacent to a body of liquid to be treated and could be on the bottom, floating, in the middle or a combination of these. The structure could have provisions for circulating flow to enhance treatment and creation of favorable growing conditions including the addition of oxygen, heating, pH adjustment, etc.

### 3.11 Objects and Advantages for a Degassing Pump

Another set of objects and advantages of the invention is a pumping system that can remove gasses as it pumps fluids. This is especially advantageous for pumping in microgravity situations where gas bubbles in liquids can cause particular problems.

Additional Advantages

Other advantages accrue to this invention and are discussed in more detail in the description and embodiment sections that follow.

### BRIEF DESCRIPTION OF THE INVENTION

### 4.1 Brief Description of Concurrent Nitrification/Denitrification/Deammonification (NDD) Treatment

The invention is single tank and/or concurrent nitrification/denitrification/deammonification of liquid containing both nitrogen and organic carbon. A substantial amount of the nitrogen in a liquid can be converted to nitrogen gas and a substantial amount of the organic carbon can be converted to carbon dioxide gas. NDD is accomplished by culturing a biome that has nitrifiers, denitrifiers, and anammox bacteria in controlled conditions to provide the oxygen necessary for nitrifiers while limiting the concentration of free oxygen that comes in contact with denitrifiers and anammox to a level which permits them to function to removal nitrogen and organic carbon from the system.

Concurrent NDD is enhanced by the control of the oxic state of wastewater at different locations and the ability to vary parameters such as pH, alkalinity, temperature, dissolved oxygen, etc. to balance the ratio of organisms and to ensure optimal treatment. This invention enhances control of the microenvironment by growth of denitrifiers and anammox on the inside of the biofilm nearest the media and nitrifiers on the outside layer of the biofilm which also acts to shield anoxic and anaerobic organisms from detrimental amounts of oxygen. NDD can be used with various forms of media including loose and anchored forms. Anchored media provides the advantage of more precise control of the microenvironment since the organisms remain attached to media in a relatively fixed area where parameters can be more precisely controlled. Also shearing of the biofilm is minimized with anchored media, and there is less need for suspended growth to assist in treatment. Anchored media also requires less energy input since mixing requirements are greatly reduced because media do not require constant mixing for suspension.

Accordingly, NDD consists of concurrent treatment nitrifiers, denitrifiers, and anammox in with a substantial portion of the biomass attached to media which provides a surface for the attachment and growth of organisms.

### 4.2 Brief Description of Patterned Fixed-Film Treatment (PFT)

Patterned Treatment (PFT) reduces variations in nutrients, oxygen, temperature, and other variables thus creating a more patterned treatment environment throughout the unit process. PFT permits the optimization of the biome and the treatment of wastewater. It permits more precise control of the environment which permits fine tuning of the process to provide precise microenvironments that are less subject to change. It should be noted that PFT does not create exact homogenous conditions throughout the tank but that the conditions remain relatively consistent or are varied on a patterned basis. For example, PFT can create an environment where oxygen is available to nitrifiers residing on the exterior of a biofilm while limiting free oxygen to the interior of the biofilm. It could also be used to uniformly cycle oxygen levels in a system, for example five minutes of 0.6 mg/l dissolved oxygen at the surface of a biofilm and ten minutes of no dissolved oxygen afterwards.

CT can make use of anchored scaffolds to achieve relatively patterned treatment. These scaffolds can keep the biofilm in a set location and can be combined with uniform mixing of the tank to homogenize the environment. Additionally, anchored scaffolds can be coupled with multiple addition locations to create relatively patterned treatment. CT also permits the conditions of a particular portion of the tank to be varied to address a particular issue in that area. For example, if one area had excessive biofilm growth, a localized backwash sequence could be initiated to restore the area to the condition of adjacent areas.

### 4.3 Brief Description of Variable Submerged Treatment (VST):

VST varies the depth of submergence of the media to improve treatment. VST permits the liquid level to be varied enable the fixed film portion of treatment to have varying exposure to both liquid and gas phases. VST can be used in a more steady-state mode for treatment or the level can be varied dynamically. Steady state mode can be more useful to maintain fairly static environmental conditions while dynamic VST can be used to cycle through various phases of treatment such a anaerobic and anoxic phases. Dynamic VST can is also well suited for combined use with PFT system. PFT retains fix-film scaffolds in a relatively stable location thus permitting better control of the microenvironment since the scaffolds do you move freely and do not pass in and out of varying conditions such as aerobic/anaerobic or high food/low food areas.

VST may consist of one or more of the following:
A structure for contain liquid, gas, and media
The media may be unattached or anchored and the submergence of the media may be varied. If the media is unattached its submergence may be varied by lowering the liquid level of the tank to expose some or all of the media.
Influent may be dispersed from the top through fixed or rotating headers or it may be introduced at the bottom of the tank or the sides. Recirculation and mixing of the influent may be performed by pumping, mixers, or air lift. In one embodiment, patterned mixing is optimal to ensure that microenvironments remain similar throughout the tank. In another embodiment, non-patterned conditions are used to selectively culture organisms in different environments that can be used to improve treatment overall.
The media may be conditioned to enhance adherence of the biofilm but surface seasoning, seeding with synergistic organisms such a macrophages, etc. The temperature of the media may also be varied directly (by applying heat or cold to thermally conductive media) or by varying liquid and/or gas temperature. Direct temperature variation can also be used to selectively increase or decrease the activity of the organisms, particularly the anaerobic/anoxic organisms closest to the media.
VST can use structured media that
   Including channels and connections for observation and instruments
   Multiple locations to add oxygen and other gasses such as nitrogen, hydrogen, carbon dioxide, air, etc.
   Multiple locations to add liquids such as micronutrients, algaecide, coagulants, polymers, etc.
   Multiple location to backwash with sparging with liquids and/or gases
   Channels and addition points may be integrally incorporated into the fixed media used thus improving efficiency and lowering costs

### 4.4 Brief Description of Septic Tank and Other Treatment Systems

A treatment system for wastewater that is capable of removing nutrients such as nitrogen and which consists of two elements, a conditioning element and a treatment element, which can be combined in one component or separated as necessary, and of which:
the conditioning element is capable of adjusting one or more characteristics of the influent wastewater where the characteristics may be selected from a group including pH, redox, dissolved oxygen, nitrites, nitrates, ammonia, ammonium, temperature (heating, cooling, and maintaining), flow, etc.
a treatment element that is capable of treating wastewater to remove nutrients and other pollutants selected from a group which includes total nitrogen, TKN, nitrate, nitrite, phosphorus, phosphate, organic carbon, suspended solids, etc.

The treatment system may have other additional elements including provision for the removal and storage of solids, clarification, filtration, ion exchange and/or removal, solids separation, screening, pumping, measurement, etc. Additional elements that a can be included in these two elements but can be better discussed as separate elements for the sake of clarity are:
a connection element to receive septic influent and discharge wastewater after treatment. The inlet element may be integral with the conditioning unit and the effluent integral with the treatment unit.
a clarification element to separate solids that may be generated from the treatment unit. This unit may be unnecessary if the growth rate of the organisms is sufficiently low, it may be separate, or it may be integrated with the conditioning unit.
An instrumentation and control element for the conditioning and for the treatment element may be integral to the respective element but is separated in this text for purposes of clarity.
A highly standardized mixture of organisms element to ensure repeatable, controllable results. This may be one mixed culture of all organisms such as nitrifiers, denitrifiers, and/or anammox or it may be separate cultures of organisms that are combined as needed to achieve the desired treatment. Cultures may be live, dormant, and/or lyophilized. Separate cultures may also be mixed, such as a mixture of organisms for nitrification, or it may be a monoculture such as a specific strain of anammox. Additionally, different mixtures and different cultures may be used depending on the treatment objectives and/or environmental conditions. The mixture could also be of organisms to colonize the conditioning element and may not be directly related to SND/deammonification treatment but may prepare the wastewater for optimal treatment. For example, a culture of cyanide degrading bacteria could be cultured and placed in a conditioning unit for a wastewater that might contain levels of cyanide that were detrimental to nitrification.
A screening element to prevent large material from entering the unit and causing damage. This element may be similar to the units used to screen effluent from a septic tank to prevent clogging of the distribution piping. The unit may be removal, cleanable, and/or replaceable and may be equipped with a high level alarm to signal if the unit is clogged.
A flow element such as a magmeter or venturi meter to measure flow. The element could measure with accuracy of most flow meters or it could be less accurate and useful to generally determine if there is a minimum flow through the unit.

### 4.5 Brief Description of Completely Integrated Wastewater Treatment System

A treatment system that is totally integrated and includes one or more of the following:
Preliminary treatment that may include coarse screening, fine screening, grinding, degritting, flow measurement and/or pumping
Primary treatment that may include solids removal by settling, flotation, and/or separation and which may be augmented by creation of centrifugal force, filtering, addition of gas to induce flotation, and/or chemicals. This may also include the removal of biosolids, scum, and other substances for reuse.
Secondary treatment that may include the removal of fine particles, colloidal matter, and dissolved substance such as suspended organics and nutrients such as nitrogen and phosphorus. This may also include the removal of nutrients and other substances for reuse.
Tertiary treatment that includes advanced treatment to further remove undesirable substances using filtration, fuel cells, etc. and which can also include removal of beneficial substance for reuse and/or the generation of energy such as electricity from a fuel cell. It can also include disinfection of wastewater and solids.
Solids handling of all substances removed in the treatment processes including those removed for beneficial reuse.

### 4.6 Brief Description of Retrofit of a System

A treatment system that can be retrofitted into an existing system. In particular, a system to remove organic carbon and/or nutrients such as nitrogen and phosphorus by retrofitting existing tanks such as those used for secondary treatment and clarification. This would include a structure that would fit inside either an aeration tank or a clarifier and could be used for NDD treatment. The structure would provide the means for NDD to occur which would facilitate the removal of both organic carbon and nitrogen where only organic carbon was substantially removed before. The structure could also be used to facilitate phosphorus removal if this is desirable.

### 4.7 Brief Description of Compact Treatment

A treatment system that is compact and whose layout permits a higher level of treatment that is normally accomplished. This is achieved by the use of membranes and scaffolds in close proximity to one another. In one embodiment the membranes are used to provide oxygen and remove treated wastewater and in which the membranes can be cycled to alternately provide either oxygen and to remove effluent. In an embodiment the scaffolds can be impregnated with dormant organisms to permit rapid activation of such a system.

In another embodiment of compact treatment, the scaffolds can be enclosed in a filtration pouch that will permit the free flow of dissolved constituents but retain microorganisms and biosolids inside the pouch. This permit treatment with a minimal amount of solids being generated outside of the pouches. The pouches can be backwashed periodically through tubing and the biosolids collected for disposal. In another embodiment the biosolids can be saved or preserved for reseeding of the reactor if needed or to be used to seed other reactors.

### 4.8 Brief Description of a Method and Means to Preserve, Store, and Reactivate Organisms and Other Substances:

A a method and means to preserve, store, and reactivate organisms and other substances consisting of enclosures, structures, processes, devices, appurtenances and mixtures of microbial organisms that can be used in the preservation, storage, and reactivation of organisms and/or other substances such as pharmaceuticals. The enclosures can be used to assist in preservation, can be used for storage, and/or can facilitate reactivation of the organisms or substances. The invention also includes structures, processes, devices, appurtenances, and mixtures of organisms that can also facilitate preservation, storage, and reactivation. One embodiment is the preservation of microorganisms grown on a structure and then preserved, stored, and reactivated at a later time. The organisms would be preserved on the structure using a protectant for preservation and storage. The structure and organisms would be enclosed in a semi-permeable membrane that would facilitate reactivation by permitting the protectant to be washed out of the structure/organism matrix while preserving the organisms on the structure. The semi-permeable enclosure could also be enclosed by a non-permeable enclosure and either vacuum packed or pressurized with inert gas to facilitate long term storage.

### 4.9 Brief Description of a Complete, Prefabricated Wastewater Treatment System

A prefabricated treatment system that is complete and can be used to treat wastewater once utilities such as power are provided. The system contains organisms in either a live or a dormant state that can be used for treatment. The system may be completely assembled and ready to use ‘as is’ or it may be delivered in components that can be quickly assembled to provide treatment.

### 4.10 Brief Description of a Floating Treatment Structure (FTS)

A treatment structure that can be used to facilitate treatment of a body of wastewater. In one embodiment the structure floats on the wastewater with part above the water surface and part below. Means are provided to promote water and air circulation. The air circulation is used to provide oxygen for aerobic organisms. The water circulation permits the wastewater to be treated as it circulates through the structure. The structure may have scaffold material that has a reticulated structure such as thermoplastic foam used in wastewater treatment (such as Porex open cell reticulated polyurethane foam). The structure may also have material that facilitates the wicking of water and the exchange of oxygen from the air. The structure may have means to ensure proper buoyancy such as integral floats. The structure may have means to promote circulation such a pump or aerator. The structure may have means to periodically be flushed to prevent clogging. The structure may have means to shield sunlight from the surface to mitigate the growth of algae. This structure may be used for NDD treatment, for iron and manganese removal, for aeration, to reduced dissolved organic carbon in reservoirs, and other types of biological and oxidation treatments.

### 4.11 Brief Description of a Degassing Pump

A pump that moves liquid and which has a gas permeable membrane which permits the release of gas from the liquid as it is pumped. One embodiment of the pump is a diaphragm pump with part or all of the diaphragm composed of a gas permeable and liquid impermeable membrane. The gas permeable membrane could be located in an area of low pressure where gas that comes out of solution at low pressure can be expelled through the membrane. The membrane could alternately be located at a point where the liquid is compressed and gas can be expelled through the membrane.

### BRIEF DESCRIPTION OF DRAWINGS—FIGS. 1-26

The file of this patent contains at least one drawing executed in color. Copies of this patent with color drawing(s) will be provided by the Patent and Trademark Office upon request and payment of the necessary fee.

FIG. 1 is a process flow diagram (PFTD) of the nitrogen and organic carbon removal process for the invention.

FIG. 2 is a schematic cross section of biofilm attached to a scaffold and showing the Nitrification/Denitrification/Deammonification process.

FIG. 3 is a schematic diagram showing a Patterned Fixed-film Treatment (PFT) system to treat wastewater. It also shows a PFT system composed of scaffolds in enclosures.

FIG. 4 is a diagram showing a Patterned Fixed-film Treatment (PFT) reactor to treat wastewater as discussed later in this application as part of the NDD testing of six reactors.

FIG. 5 is a schematic side view of a Patterned Fixed-film Treatment (FTS) system.

FIG. 6 is a schematic of a Variable Submerged Treatment (VST) reactor.

FIG. 7 is a wastewater system for space, reduced gravity, and other environments

FIG. 8 is a process flow diagram showing a treatment system as an ‘add-on’ unit to a septic tank and drain field.

FIG. 9 is a process flow diagram that shows additional details for the conditioning and/or treatment element(s).

FIG. 10 is a top and side view of a septic add on unit.

FIG. 11 is a Process Flow Diagram of an add-on unit for septic systems.

FIG. 12 is a Process flow diagram of a complete, integrated wastewater treatment system.

FIG. 13 is a schematic diagram of a compact treatment system in a cubic format.

FIG. 14 is a schematic diagram of a compact treatment system in a cylindrical format.

FIG. 15 is an enclosure, structure, process, device, and appurtenance for the preservation, storage, and reactivation of microorganisms.

FIG. 16 is a reactor that contains scaffolds for biofilms with inner and outer structures, mixers, a feed inlet, a heater, air stones, and a raised grid to improve circulation.

FIG. 17 is an enclosure with a permeable mesh that can be used to dissolve material inside the enclosure and cause it to exit the enclosure while retaining organisms and other items that are larger than the pore size of the material.

FIG. 18 is a structure that may contain additional sub-structures. This structure can be part of Patterned Fixed-film Treatment (PFT) and could remain in place during preservation for long term storage using lyophilization, induced dormancy, or other preservation method. This structure could also be removed for preservation.

FIG. 19 is a process flow diagram diagram showing the preservation, storage, and reactivation of organisms.

FIG. 20 is a device such as a lyophilizer to preserve organisms

FIG. 21 is an appurtenance such as a liquid nitrogen spray delivery system that is part of the device to preserve organisms.

FIG. 22 is a lyophilization system that can be stand alone or integrated into a treatment system.

FIG. 23 is a prefabricated, complete wastewater treatment system consisting of a treatment tank, clarifier tank, scaffold with organisms, and a unit with pre-mounted equipment and piping that can be installed quickly.

FIG. 24 is of a floating treatment system.

FIG. 25 is of a diaphragm degassing pump.

FIG. 26 is of a peristaltic degassing pump.

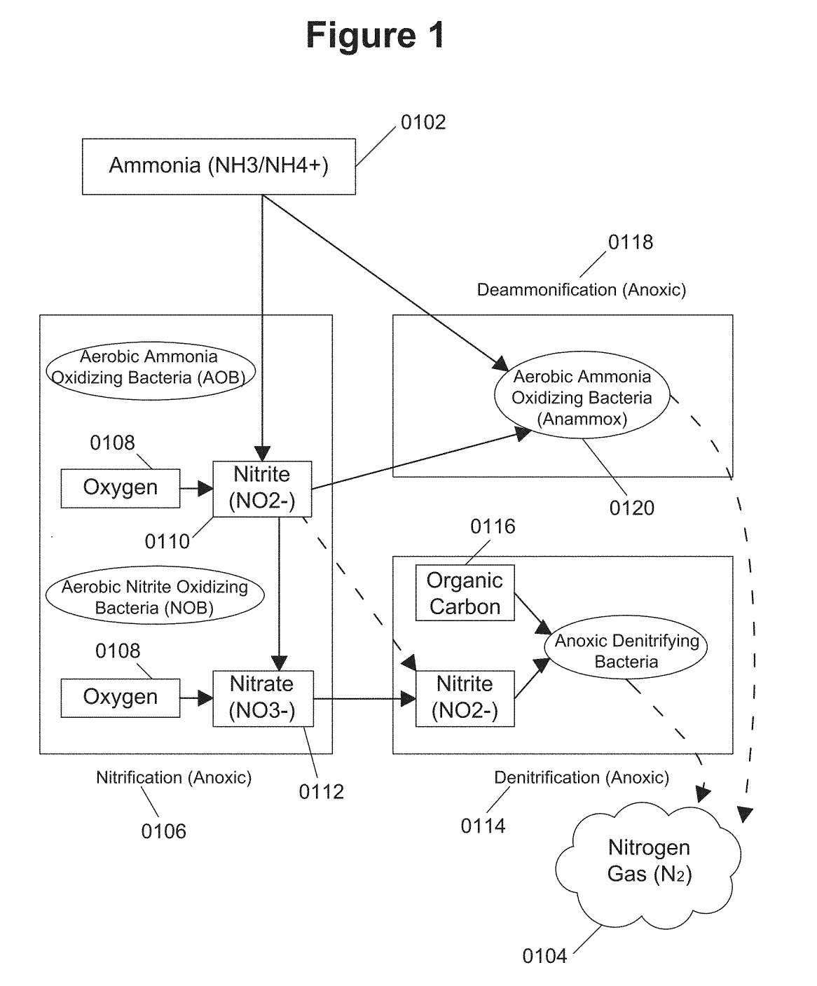

### MORE DETAILED DESCRIPTION OF FIGURES—FIGS. 1-26

FIG. 1 is a process flow diagram (PFTD) of the nitrogen and organic carbon removal process for the invention. The figure illustrates the need to balance the activity and growth of various sets of organisms to optimize treatment. The Nitrification/Denitrification/Deammonification (NDD) PFTD illustrates the requirements of each of the three major processes to covert Ammonia (0102) to Nitrogen Gas (0104). Nitrification (0106) requires the addition of oxygen (0108) to convert ammonia to nitrite (0110) and nitrate (0112). Denitrification (0114) requires organic carbon (0116) to convert nitrite to nitrogen gas. Deammonification (0118) using Anammox (0120) requires nitrite from the nitrification process to convert ammonia to nitrogen gas. These processes need to be balanced to remove the maximum amount of organic carbon and ammonia. Since denitrification is the only process to remove organic carbon it must receive sufficient nitrite and nitrate for use in this process. Once sufficient nitrite and nitrate is supplied to degrade it and the organic carbon present, the deammonification process is need edto removal excess nitrogen beyond what the denitrifiers may be able to remove alone.

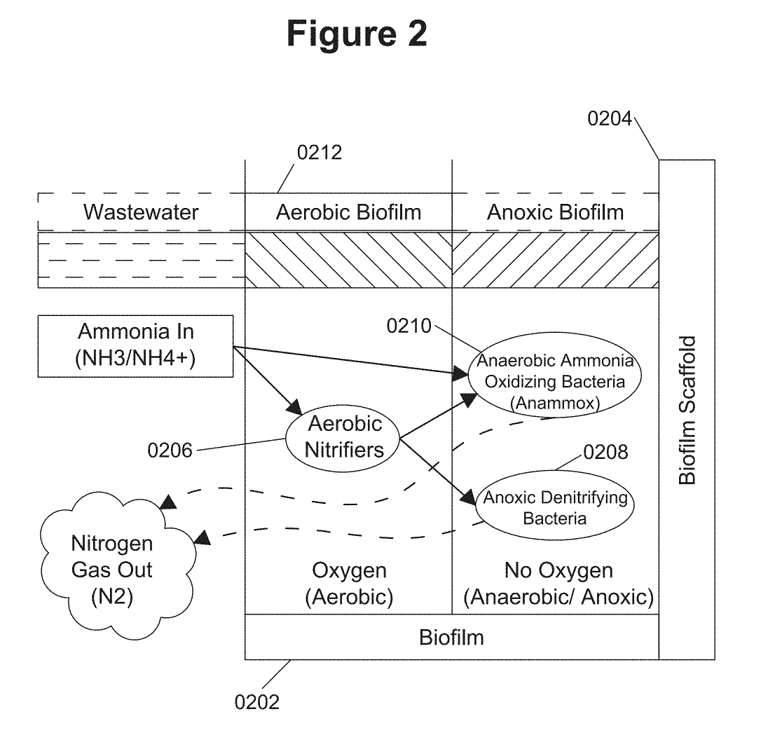

FIG. 2 is a schematic cross section of biofilm (0202) attached to a scaffold (0204) and showing the Nitrification (0206)/Denitrification (0208)/Deammonification (0210) process. The schematic illustrates how the aerobic outer biofilm layer (0212) has nitrifiers which convert ammonia to nitrite and nitrate to be used in denitrification and deammonification but also shields the inner biofilm composed of denitrifiers and anammox from free oxygen, which will hinder their performance if present. In reality the biofilm is much more complex and organism location varies more, however, the schematic shows the overall general average of the required biofilm structure.

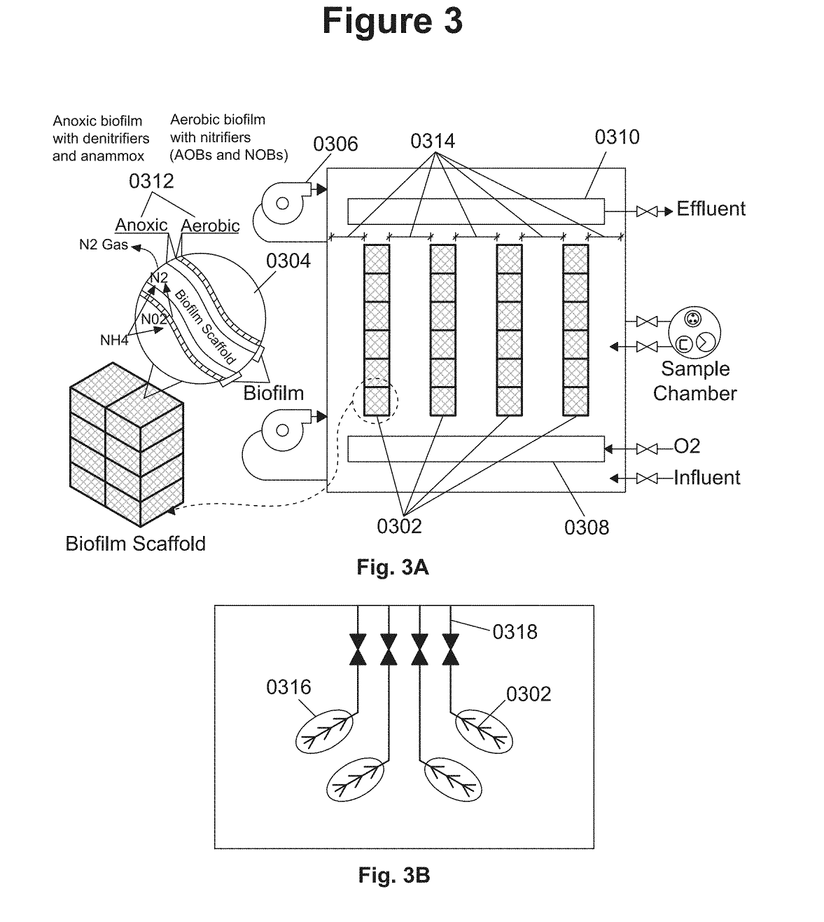

FIG. 3 is a schematic diagram showing a Patterned Fixed-film Treatment (PFT) system to treat wastewater. A reactor is shown with several scaffolds (0302) which support the growth of a biofilm (0304). A circulation pump (0306) mixes the fluid in the reactor and oxygen is provided by a membrane (0308) in the reactor. Effluent is removed with another membrane (0310). The scaffold supports the growth of an NDD biofilm (0312). The scaffolds are placed to permit the liquid to come in contact relatively equally with all of the scaffolds (0314). The process is monitored in a separate sampling/monitoring chamber (0316). The figure also shows a PFT system composed of scaffolds (0302) in enclosures that may be semipermeable membranes (0316) with piping (0318) to inject gas and liquid and also withdraw effluent and excess biosolids.

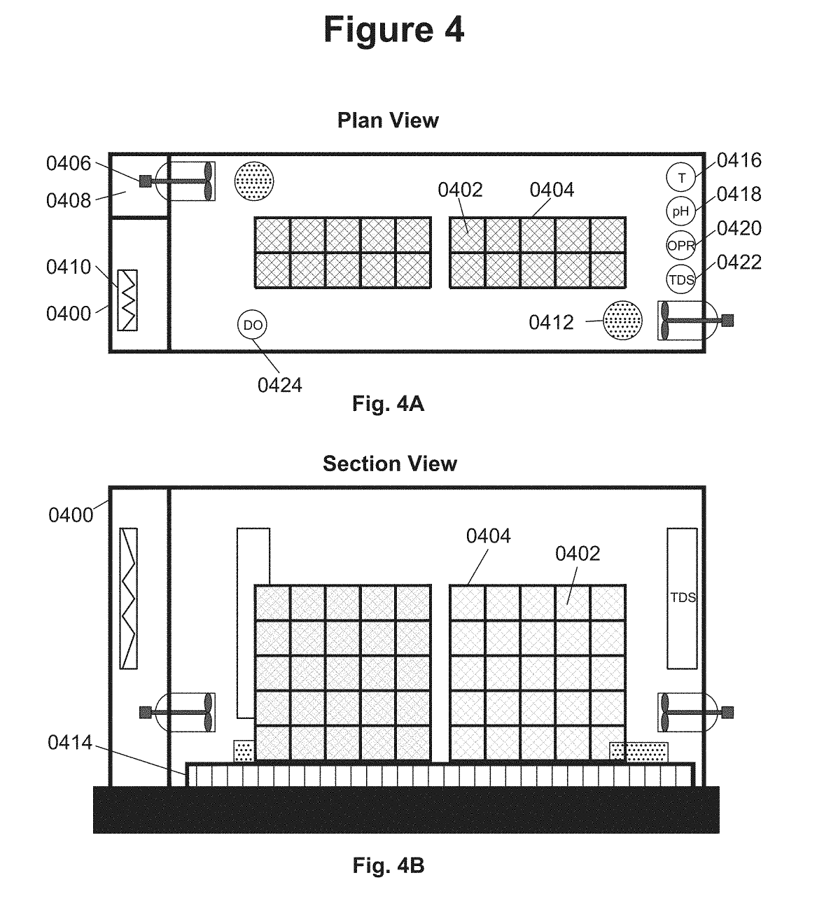

FIG. 4 is a diagram showing a Patterned Fixed-film Treatment (PFT) reactor to treat wastewater as discussed later in this application as part of the NDD testing of six reactors . In this configuration the scaffolds are located in a central area and the fluid to be treated circulates evenly throughout the reactor. Oxygen is added by air stones and is rapidly and evenly dispersed in the fluid.

A reactor (0400) that contains scaffolds for biofilms with inner (0402) and outer (0404) structures, mixers (0406), a feed inlet (0408), a heater (0410), air stones (0412), and a raised grid to improve circulation (0414). The reactor also has the following probes to monitor the process and permit control of the system as desired: temperature (0416), pH (0418), oxygen reduction potential (0420), total dissolved solids (0422), and dissolved oxygen.

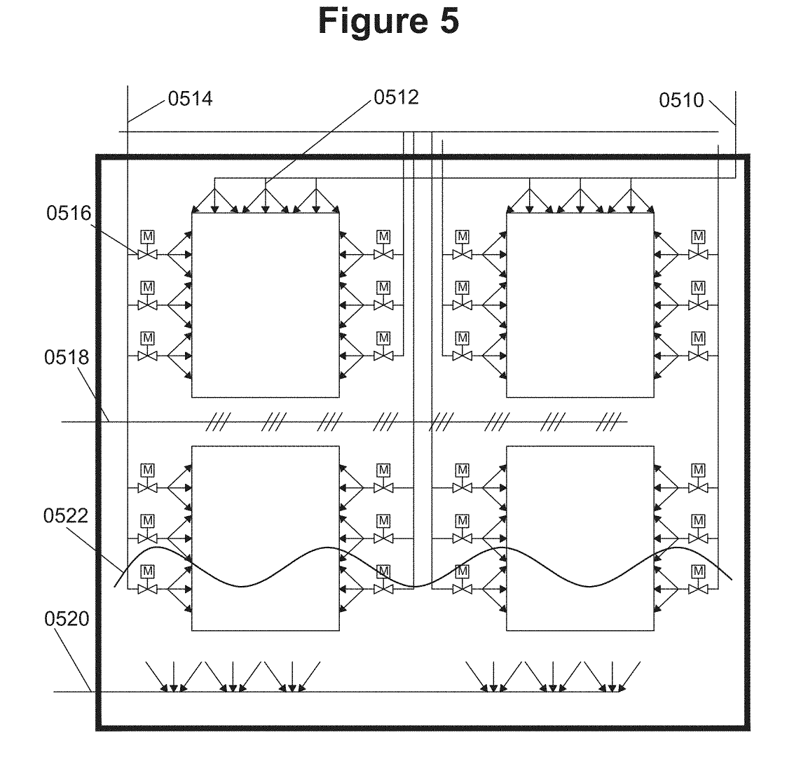

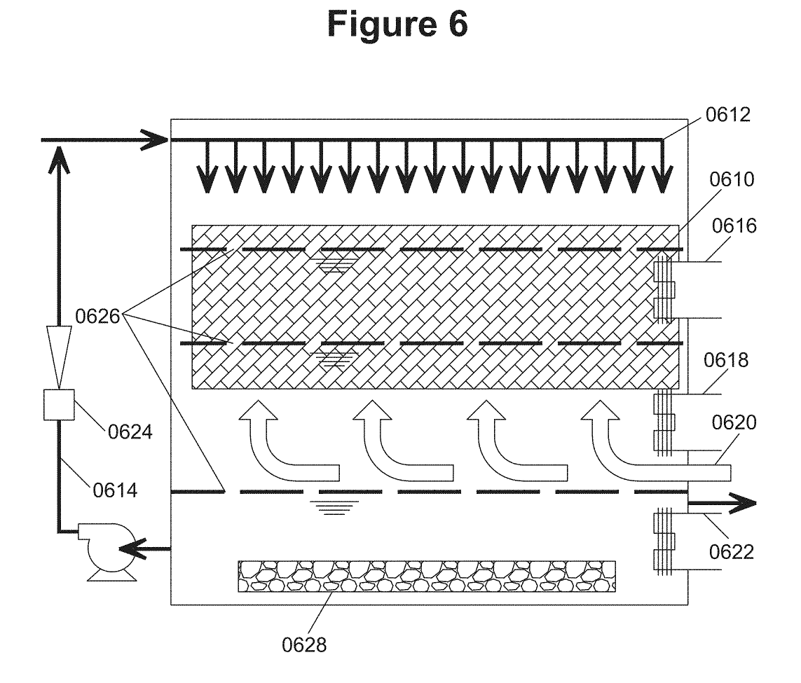

FIG. 5 is a schematic side view of a Patterned Fixed-film Treatment (FTS) system. Influent (0510) flow can be even distributed (0512) along the top of the system. In a variant it could be added in one location of there was good mixing of the entire system or it could be added in multiple locations in addition to the top if desired. There could be a multiplicity of points to add gases such as oxygen and liquids or to take samples (0514) and these points could have separate controls (0516) to permit adjustment of local conditions. Instruments could be embedded at multiple points (0518) to permit more precise control of local points in the system. Effluent can be withdrawn from multiple points (0520) along the bottom of the reactor and can be recycled as desired. This system could be combined with variable submerged treatment (discussed below and shown in FIG. 6) to vary conditions at points in the reactor.

FIG. 6 is a schematic of a Variable Submerged Treatment (VST) reactor. This drawing shows how influent flow can be evenly distributed in the reactor along the top (0610). Oxygen and other gasses and fluids can be evenly dispersed throughout the reactor by multiple addition points (0612). Effluent can be withdrawn from multiple points along the bottom of the reactor and can be recycled as desired (0614). Air and chemicals can be inducted in wastewater as it is recycled though the system.

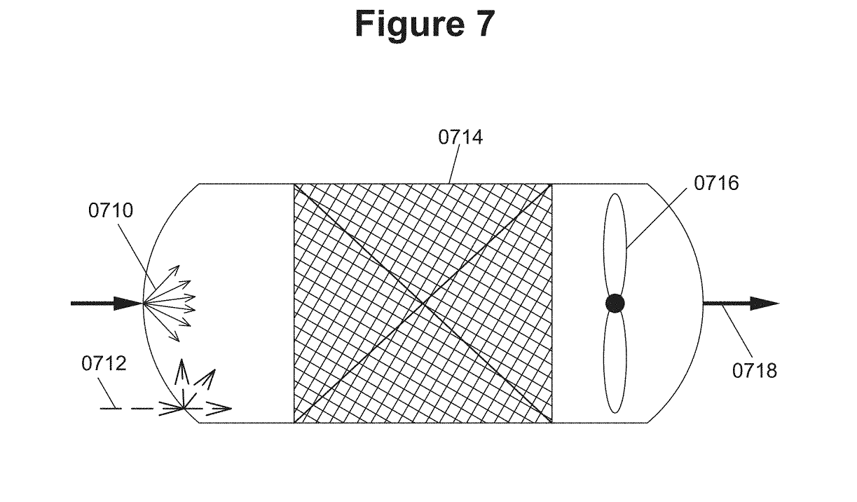

FIG. 7 is a wastewater system for space, reduced gravity, and other environments which includes a spray dispersion system for the wastewater (0710), a gas (and liquid) dispersion system (0712), monolithic (0714) or other structured or fixed-film system, and an exhaust/repressurization system (0716).

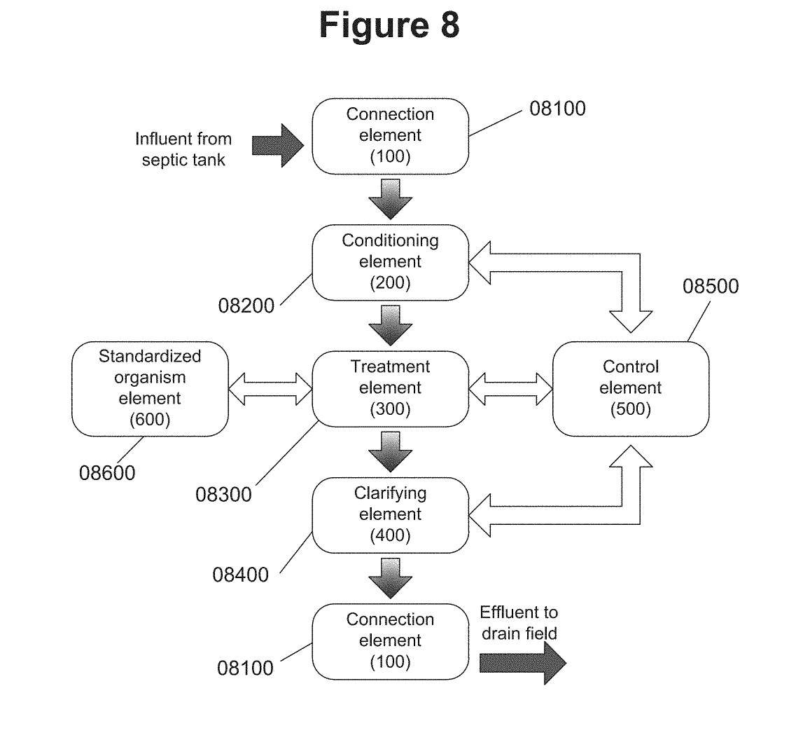

FIG. 8 is a process flow diagram showing a treatment system as an ‘add-on’ unit to a septic tank and drain field. The unit consists of at a minimum of a conditioning element (08200) and a treatment element (08300). Additional elements shown separately on this figure, but which may be integrated into the conditioning and/or treatment element, include a connection element (08100), a clarification element (08400), and an instrumentation and control element (08500). The standardized culture of organisms (08600). These are functional elements and can be combined into one unit.

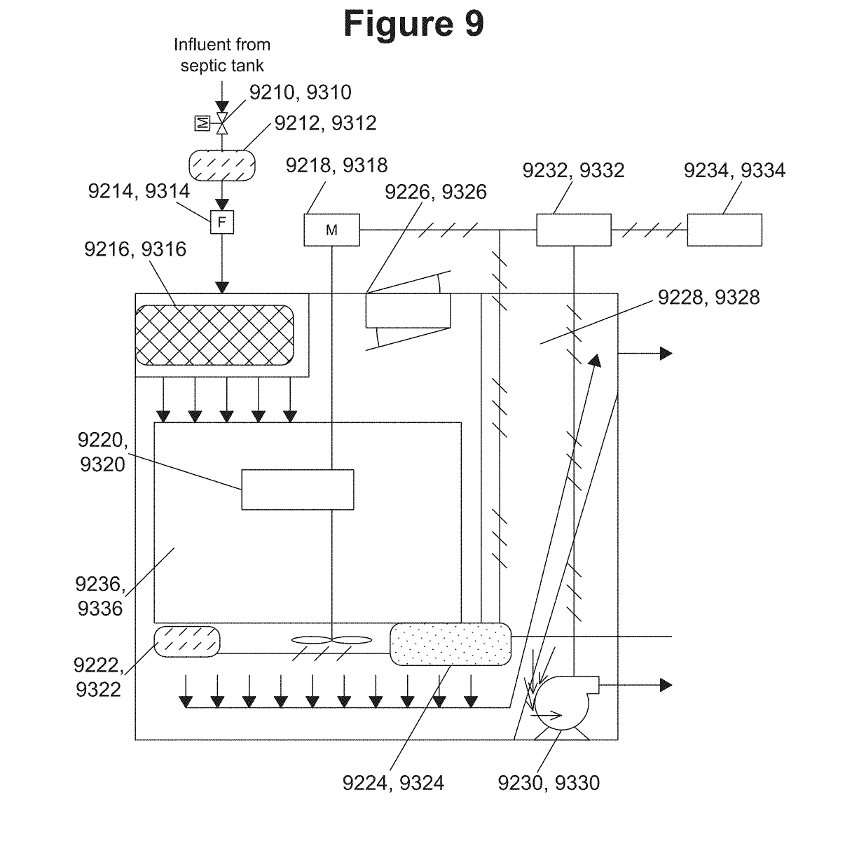

FIG. 9 is process flow diagram that shows additional details for the conditioning and/or treatment element(s) for the following items (note ‘92xx’ is for conditioning and ‘93xx is for treatment):
a connection element(s) (9210, 9310),
a screening element (9212, 9312),
a flow measuring element (9214, 9314),
an influent dispersion element (9216, 9316),
a mixing element (9218, 9318),
media (9220, 9320),
a heating/cooling element (9222, 9322)
an aeration element (9224, 9324)
a method to add materials (9226, 9326) as necessary (adjusting chemicals, heat, micronutrients, etc.)
a method to separate solids (9228, 9328) before effluent exits unit (clarifier, membrane, filter, etc.)
a solids removal pump (9230, 9330)
a control system (9232, 9332)
a telemetry system (9234, 9334)
a standardized organism mixture element (9236, 9336)

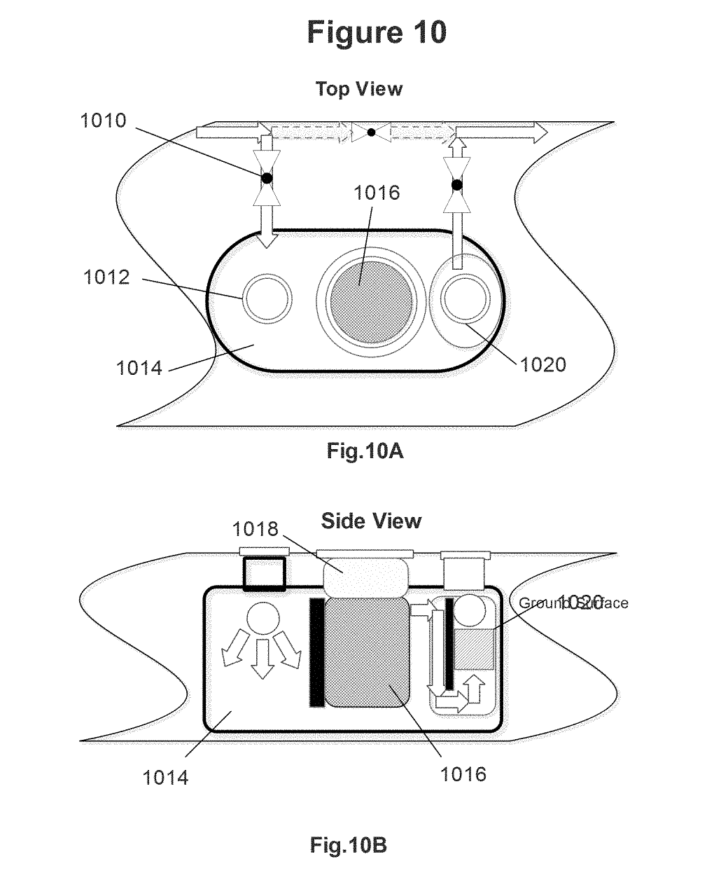

FIG. 10 is a top and side view of a septic add on unit. The connection element (1010) feeds to the unit and from the unit. There is an access hatch (1012) for the conditioning unit for servicing and replacing pH conditioner. The conditioning unit (1014) has sufficient room for storage of 6 months to a year of conditioner and other items. The treatment unit (1016) has a removable core that is accessed by removing the instrumentation and controls (1018) which can be mounted elsewhere in other embodiments. The clarification unit (1020) also has an access hatch for maintenance and inspection.

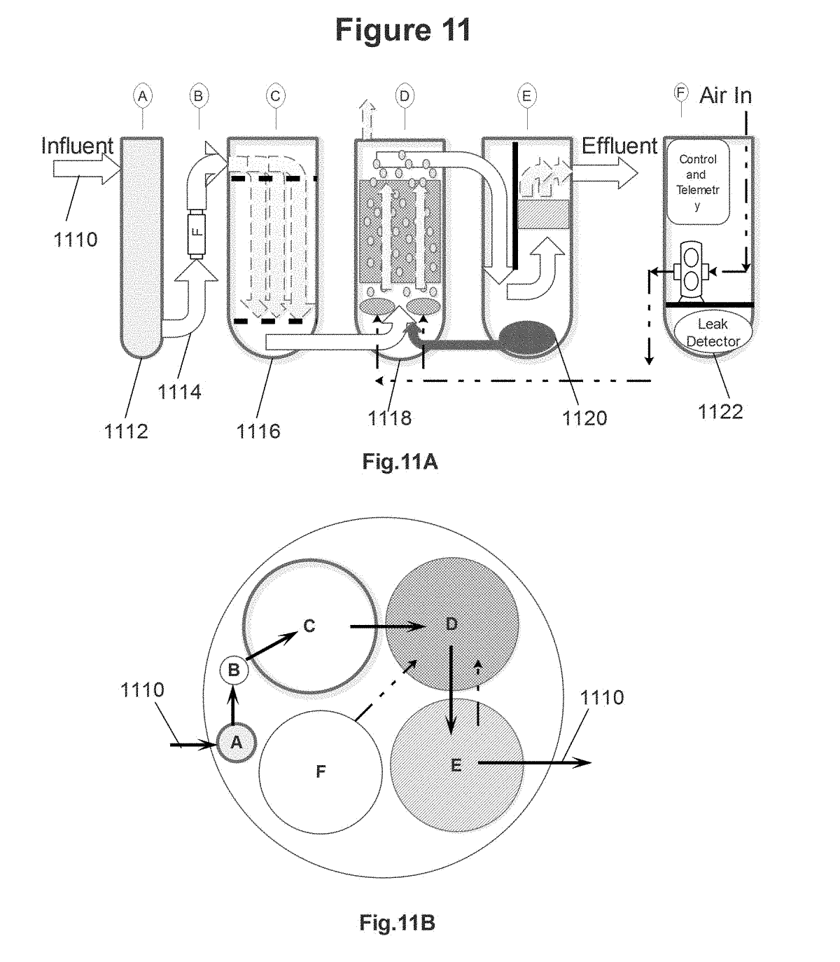

FIG. 11 is a Process Flow Diagram of an add-on unit for septic systems. The connection elements (1110) route flow to and from the unit. There is a screening element (1112), a flow metering element (1114), and conditioning element (1116), a treatment element (1118), and a clarification element (1120). There is also a monitoring and control element (1122). The bottom of the figure shows these elements arranged within a circular structure similar to a manhole.

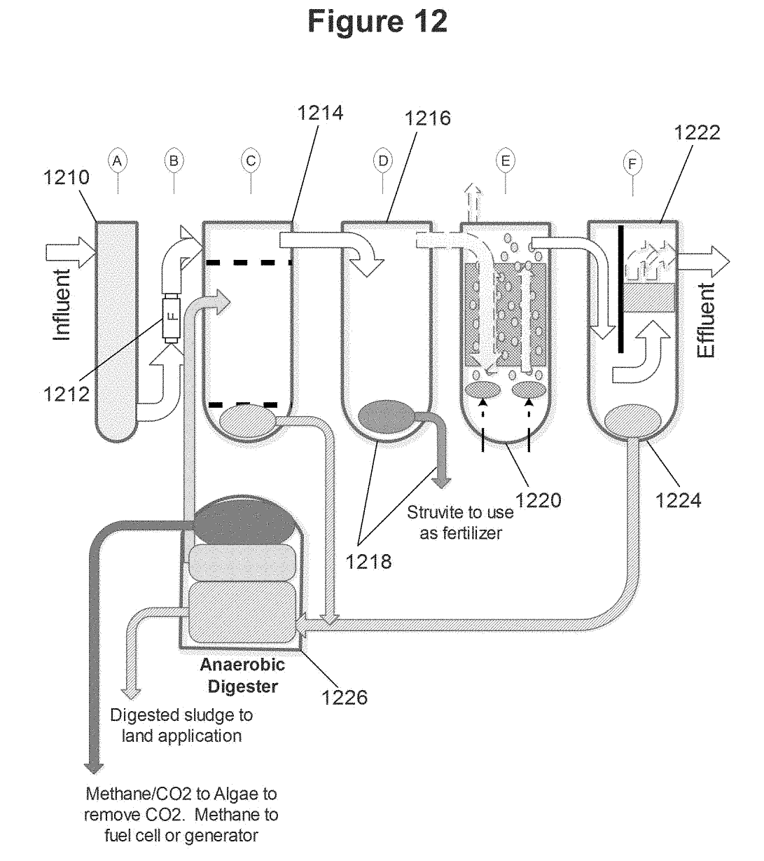

FIG. 12 is a Process flow diagram of a complete, integrated wastewater treatment system. The influent is screened and/or ground (1210) to prevent downstream clogging and to condition the material for further treatment. There is metering unit (1212) and a settling and/or flotation unit (1214). This unit may be anaerobic in which case the gas generated can be piped to the digester (1226) or a fuel cell to provide additional energy. Flow from the settling unit proceeds to the nutrient recovery unit (1216) where the flow is conditioned to precipitate out nitrogen and phosphorus in the form of some other form suitable for use as fertilizer (1218). Remaining organics and nitrogen are treated in an NDD polishing unit (1220) and proceeds to a solids separator/clarifier (1222) which may be replaced or followed by membrane treatment. Residuals (1224) from clarification and settling are sent to a digester (1226) where it is treated for reuse. Treated biosolids are sent for land application, filtrate is routed back through the process, and methane/CO2 is purified though the use of algae or other process to remove CO2 and the methane is used to generate power via fuel cell or by use in a generator.

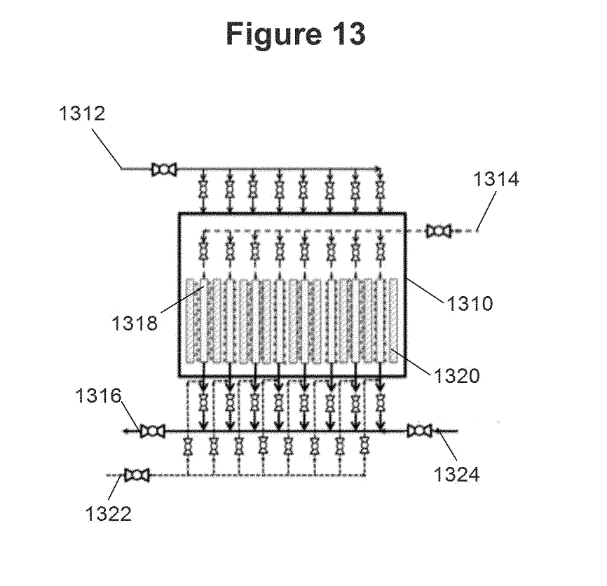

FIG. 13 is a schematic diagram of a compact treatment system in a cubic format (1310). Typical valve position (O=open; X=closed) is shown, however, it should be noted that the air and effluent valves periodically change from O to X and X to O to switch the membrane use from oxygen addition to effluent withdrawal and vice versa. The influent is routed through an influent valve manifold (1312) that distributes influent flow evenly, or which can throttle flow to an area as needed if reduced flow is necessary. During normal operation all valves are open. Air, oxygen, or other gas is fed through the gas manifold (1314) which normally has half of its valves open to feed gas through half the membranes. The other half of the membranes are used to withdraw effluent through the effluent manifold (1316). Periodically, the valve positions of the air and effluent manifolds to the individual membranes (1318) are switched. This promotes even flow and biofilm growth on the scaffolds while minimizing fouling of the membranes. Scaffolds (1320) are located between the membranes to support biofilm growth. Isolation valves and access are provided for removal of membranes and scaffolds as needed. The membranes can be backwashed periodically using the backwash manifold (1322) and cleaning can be accomplished through another manifold (1324) which can add chemicals and which can also be used to add other items such as micronutrients or algaecides as necessary.

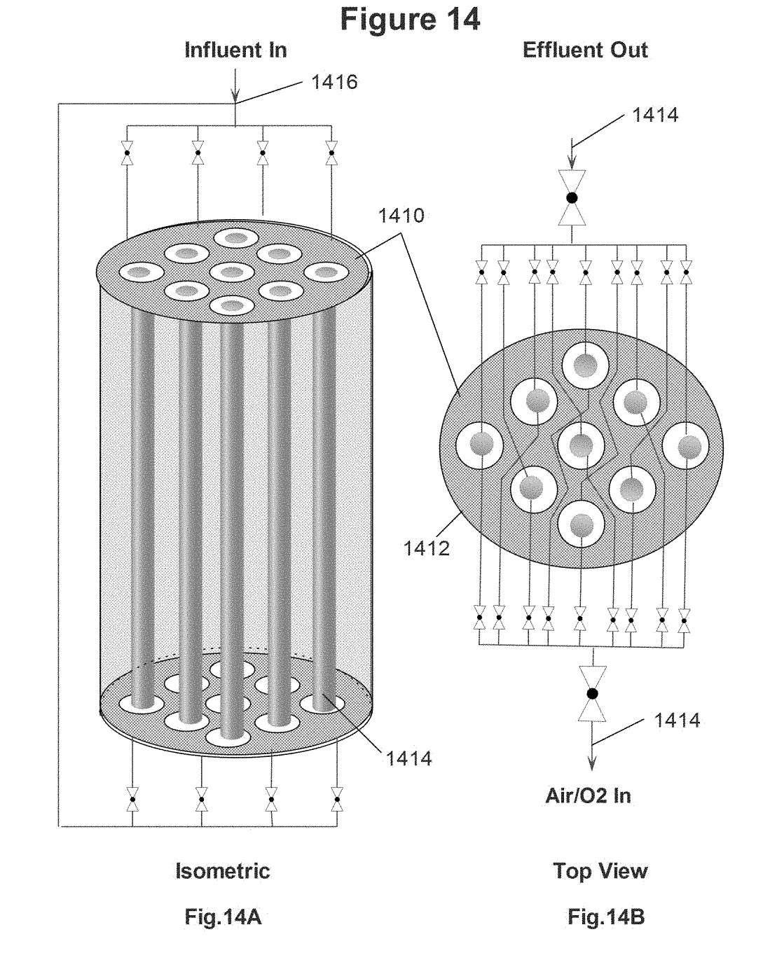

FIG. 14 is a schematic diagram of a compact treatment system in a cylindrical format (1410). The system is similar to a cubic system with the main difference that the scaffolds (1412) surround the cylindrical membranes (1414). Valving manifolds are similar to those used in the cubic format. For clarity, only the influent (1416), effluent (1418), and gas (1420) manifolds are shown on the drawing.

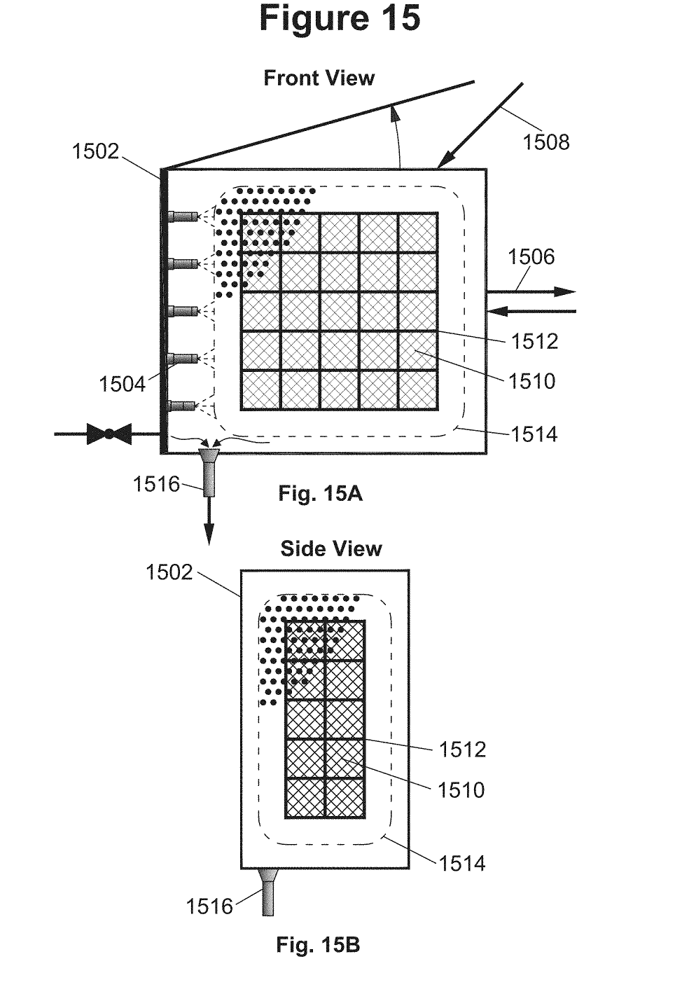

FIG. 15—An enclosure, structure, process, device, and appurtenance for the preservation, storage, and reactivation of microorganisms. FIG. 15 shows a lyophlizing (freeze drying) device (1502) that can spray liquid nitrogen (1504) as part of the freeze drying process (1506). A cryoprotectant (1508) can be added to help maintain organism's viability. A scaffold to support biofilm growth with an inner structure (1510) (such as Poret open cell reticulated polyurethane foam) and an outer structure (1512) (such as a stainless steel cage) can be inserted into the lyophilizer. This structure may also be enclosed by a permeable or impermeable enclosure (1514). The lyophilizer may also be equipped with a drain (1516).

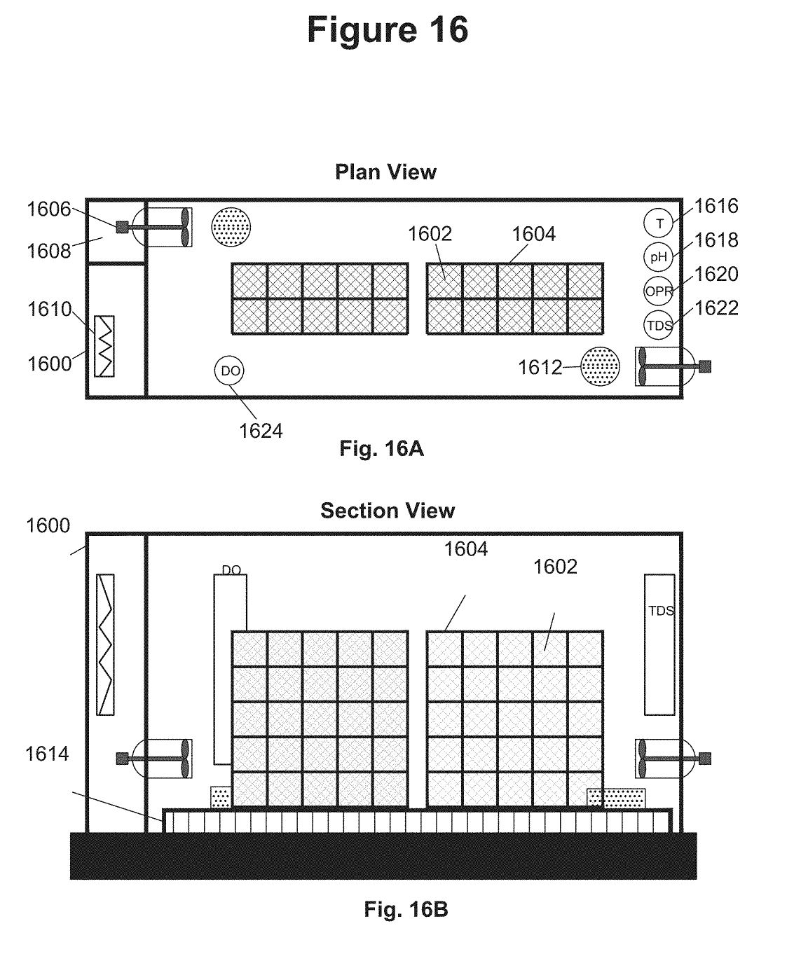

FIG. 16—An reactor (1600) that contains scaffolds for biofilms with inner (1602) and outer (1604) structures, mixers (1606), a feed inlet (1608), a heater (1610), air stones (1612), and a raised grid to improve circulation (1614). The reactor also has the following probes to monitor the process and permit control of the system as desired: temperature (1616), pH (1618), oxygen reduction potential (1620), total dissolved solids (1622), and dissolved oxygen.

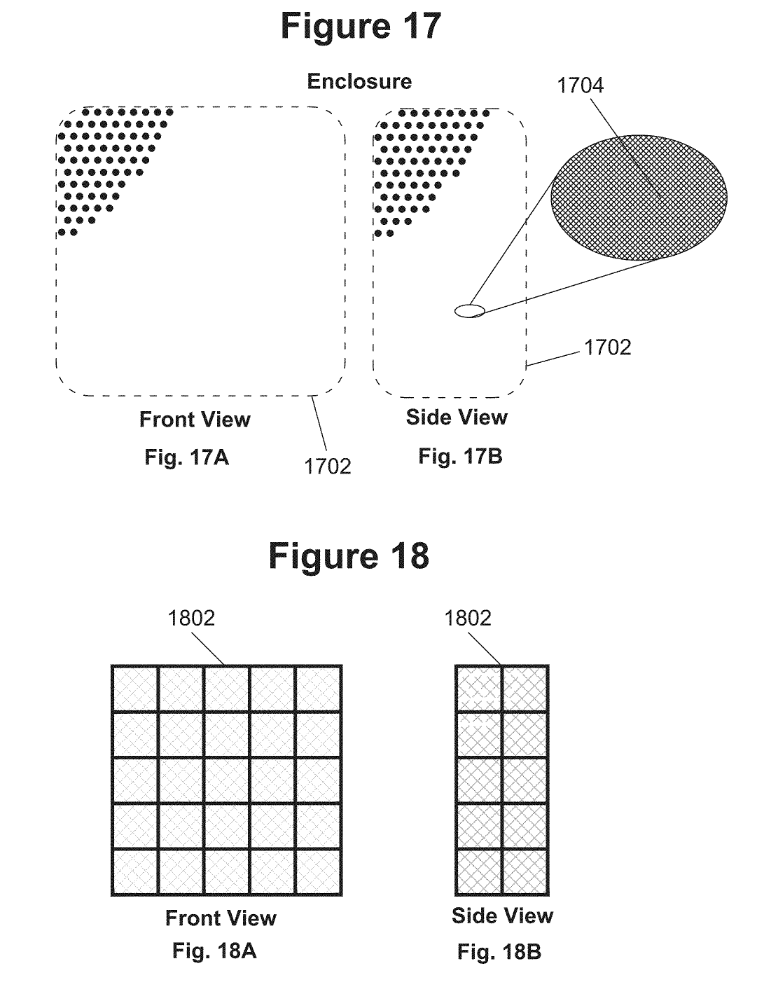

FIG. 17—An enclosure (1702) with a permeable mesh (1704) that can be used to dissolve material inside the enclosure and cause it to exit the enclosure while retaining organisms and other items that are larger than the pore size of the material. This mesh also minimizes turbulence during the dissolution process and helps keep biofilm from falling from the scaffolds. The enclosure with permeable mesh can be contained in a larger impermeable enclosure which permits long term storage in a low humidity, controlled setting.

FIG. 18—A structure (1802) that may contain additional sub-structures. This structure can be part of Patterned Fixed-film Treatment (PFT) and could remain in place during preservation for long term storage using lyophilization, induced dormancy, or other preservation method. This structure could also be removed for preservation.

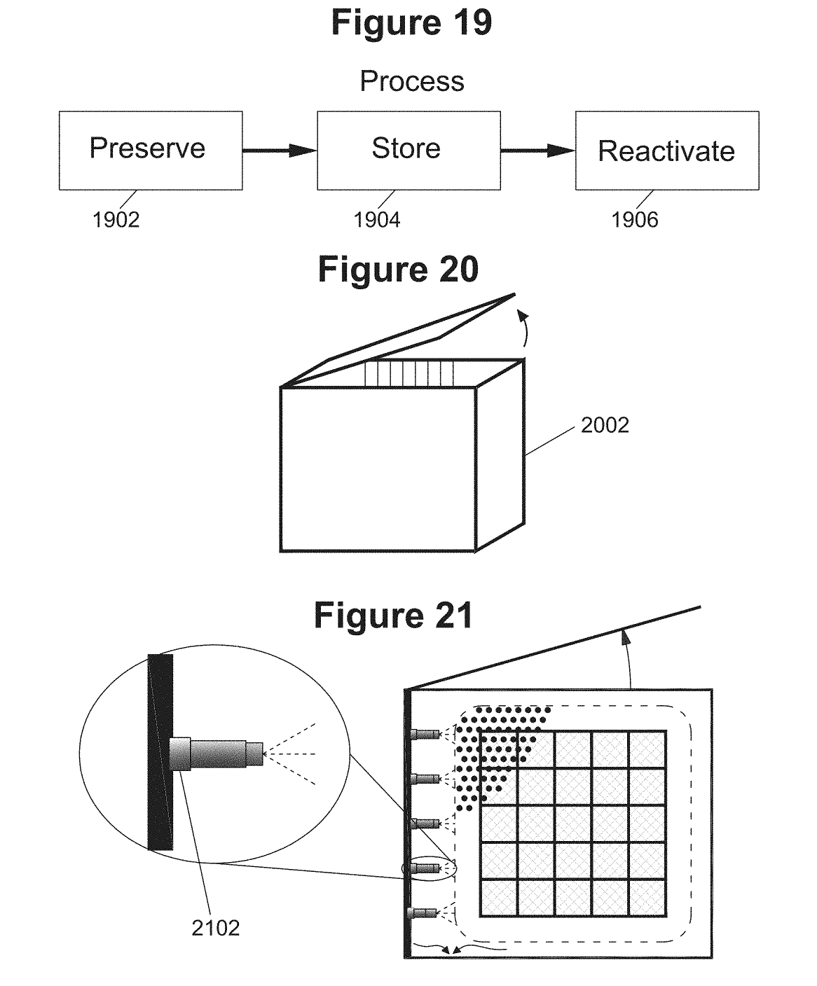

FIG. 19—A process flow diagram diagram showing the preservation (1902), storage (1904), and reactivation (1906) of organisms.

FIG. 20—A device (2002) such as a lyophilizer to preserve organisms

FIG. 21—An appurtenance (2102) such as a liquid nitrogen spray delivery system that is part of the device to preserve organisms.

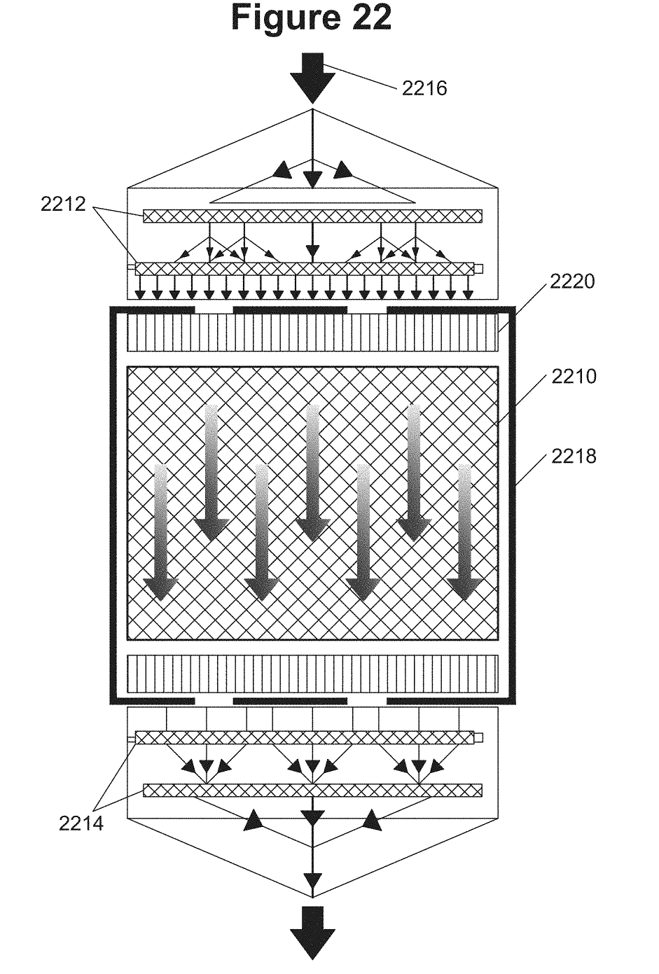

FIG. 22—is a lyophilization system that can be stand alone or integrated into a treatment system. As a standalone system the scaffold (2210) would be inserted into the unit and cryoprotectant would be added and distributed evenly (2212) thoughout the scaffold. Excess cryoprotectanct would then be collected (2214). The scaffold would then be lyophilized in the unit. A permeable enclosure and/or impermeable enclosure similar to that showing in FIG. 17 could then be added.

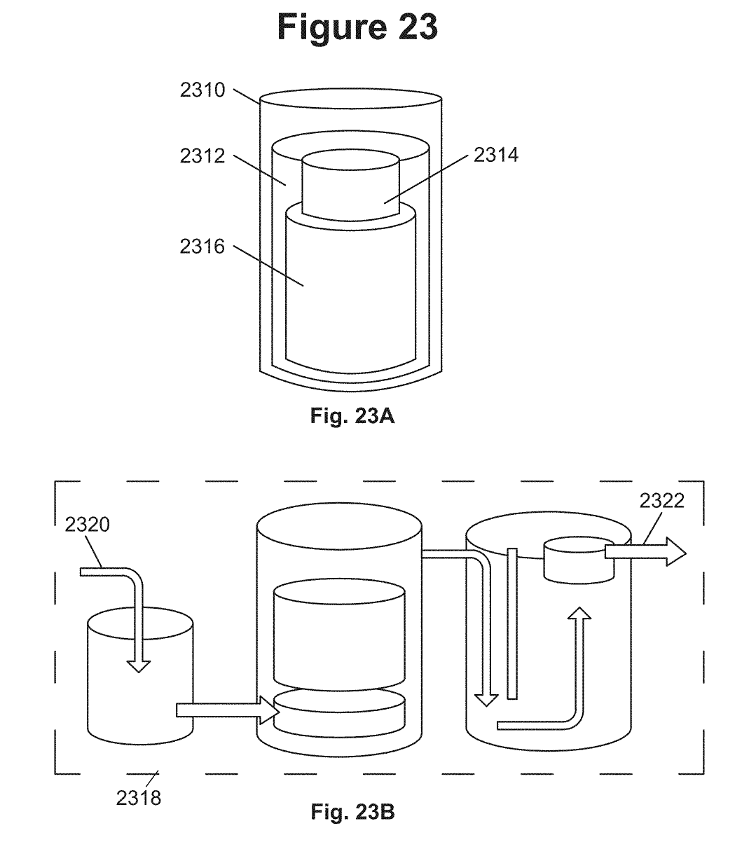

FIG. 23 is a prefabricated, complete wastewater treatment system consisting of a treatment tank (2310), clarifier tank (2312), scaffold with organisms (2314), and a unit with pre-mounted equipment and piping that can be installed quickly (2316). The unit could be assembled on site as showing in the drawing (2318). In a variant, the unit could be installed on site as a completed unit and could treat wastewater immediately (or in a very short time if the organisms are stored for long term preservation (such as lyophilization) when connect to power.

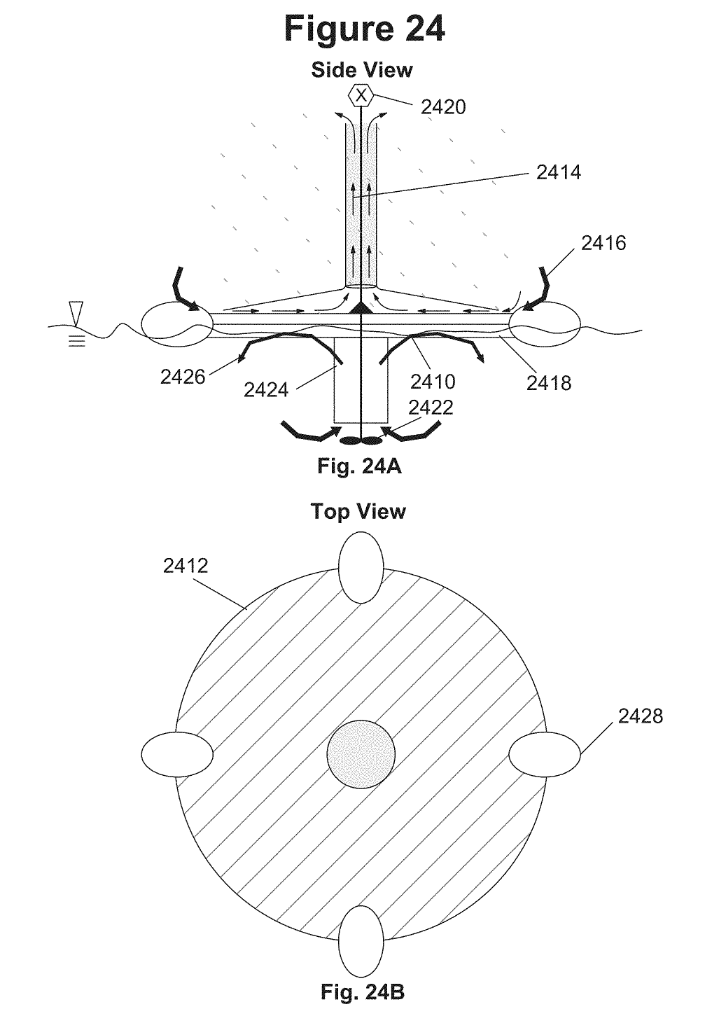

FIG. 24 is of a floating treatment system. The system is composed of a partially submerged scaffold (2410) that is covered by a material (2412) that absorbs sunlight causing the air under the cover to heat and to wick up to through a central solar chimney (2414) thus causing air to circulate (2416) through the partially submerged scaffold to provide oxygen to the aerobic organisms (2418) in the biofilm. On the top of the system is a structure (2420) that permits water to circulate. The structure may be a solar panel with motor that drive a propeller (2422) to move water along a vertical column (2424) and then to exit and flow through (2426) the partially submerged scaffold. Or the structure (2420) could be a material that sorbs heat from the sun and transfers it down to the water where it heat the water and the less dense water upwells through the column (2424). Or the structure (2420) could be similar to a rotating roof ventilator and is it turns it could turn the propeller below the column thus inducing upwelling in the column. The structure has floats (2428) to stabilize and protect the structure.

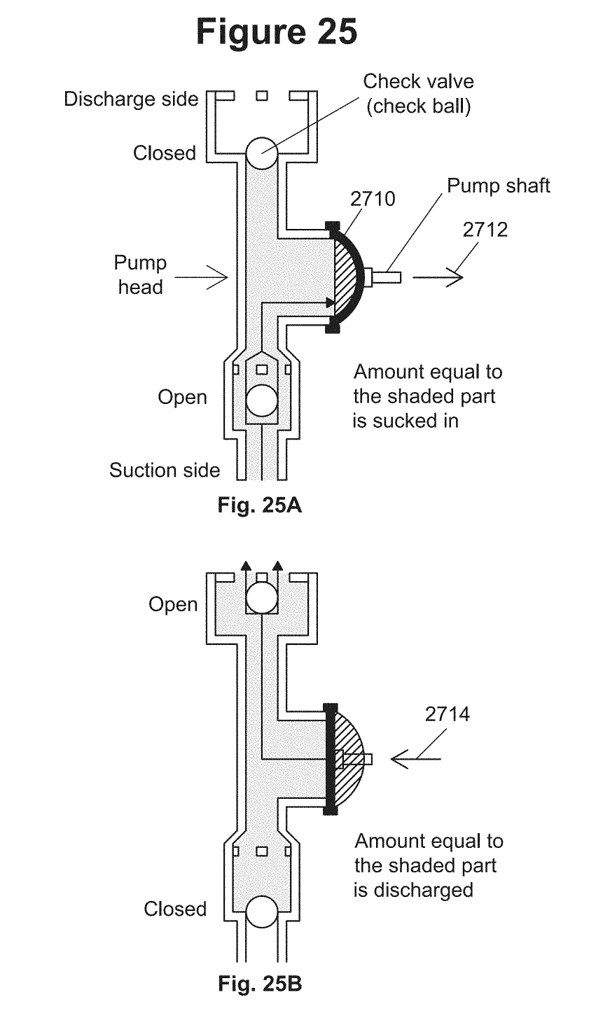

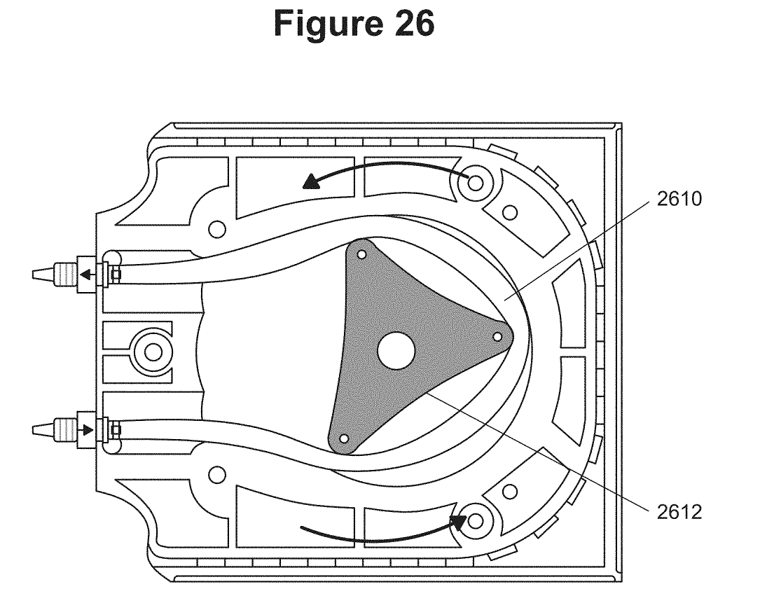

FIG. 25 is of a diaphragm degassing pump. The pump diaphragm (2510) is composed partially or completely of a gas permeable, liquid impermeable membrane. When the pump shaft pulls out the diaphragm on the inlet stroke (2512) the liquid fills the chamber. The rapid action of the inlet stroke also creates a lower pressure regime which can cause dissolved gasses to come out of solution. During the outlet stroke the diaphragm compresses the fluid (2514) and any gasses can exit through the gas permeable membrane.

FIG. 26 is of a peristaltic degassing pump. The pump tubing (or hose) is composed partially or completely of a gas permeable, liquid impermeable membrane. When the pump rotor turns it progressively compresses the tubing (or hose) which moves the fluid through the pump. Gasses present in the liquid can exit through the gas permeable membrane.

### 7 Description of Invention

### 7.1 Description of Nitrification/Denitrification/Deammonification (NDD) Treatment

### 7.1.1 Overall Description of Nitrification/Denitrification/Deammonification (NDD) Treatment

The invention is concurrent nitrification/denitrification/deammonification of wastewater containing both nitrogen and organic carbon. Using NDD, a substantial amount of the nitrogen in the wastewater can be converted to nitrogen gas, and a substantial amount of the organic carbon can be converted to carbon dioxide gas by balancing the microbial reactions of the nitrifiers, denitrifiers, and anammox organisms. Concurrent NDD is enhanced by the control of the oxic state of wastewater at different locations and the ability to vary parameters such as pH, alkalinity, temperature, dissolved oxygen, etc. to balance the ratio of organisms and to ensure optimal treatment. This invention enhances control of the microenvironment by stimulating growth of denitrifiers and anammox on the inside of the biofilm nearest the media, and stimulating growth of nitrifiers and other aerobic organisms on the outside layer of the biofilm, with this outside aerobic layer of organisms also acting to shield the anammox and denitrifiers from free oxygen. NDD can be used with various forms of media including loose and relatively fixed forms. Fixed, or relatively anchored media provides the advantage of more precise control of the microenvironment since the organisms remain in a relatively fixed area where parameters can be more precisely controlled. Also shearing of the biofilm is minimized with structured media that further enhances treatment and protects the inner layer of organisms from free oxygen. Higher organism density can be supported on fixed media and if this is coupled with good mixing there is less need for suspended growth of unattached organisms to assist in treatment. Fixed, anchored, or structured media can also be arranged in a patterned manner and can be coupled with complete mixing that requires less energy input oxygen and that can disperse other wastewater constituents in a more efficient manner.

A preferred embodiment of NDD consists of the growth of nitrifiers, denitrifiers, and anammox in one tank with a substantial portion of the biomass attached to media which provides structural support for the organisms and provide a place for growth. In one embodiment that media is structured in a substantially patterned manner.

Biological Removal of Organic Carbon and Nitrogen

Biological wastewater treatment systems designed to remove high levels of organic carbon and nitrogen, such as found in sidestreams in wastewater treatment plants or in wastewater composed mainly of ammonia (such as wastewater generated at the International Space Station), generally rely on a mixture of organisms that are able to remove organic carbon by converting it to carbon dioxide and either remove ammonium as nitrogen gas and/or to convert it to nitrite or nitrate. A combination of two of three groups of organisms are generally used synergistically for this type of treatment. These groups are nitrifiers, denitrifies, and anaerobic ammonia oxidizing (anammox) bacteria. Nitrifiers are sometimes subdivided further to distinguish between organisms that convert ammonia to nitrite (ammonia oxidizing bacteria, or AOBs) and bacteria that convert nitrite to nitrate (nitrite oxidizing bacteria, or NOBs).

Nitrification and denitrification can be combined in a mixed process occurring in one tank and the process is termed concurrent nitrification/denitrification or SND. SND makes use of the available carbon in the wastewater to serve as an energy source for denitrifiers to achieve at least partial denitrification. If sufficient carbon is not available to convert all ammonia to nitrogen gas, SND will convert the remaining ammonia to nitrate.

It is also possible to convert ammonia to nitrogen gas using a process termed ‘deammonification’. This process first involves converting a portion of the ammonia in the wastewater to nitrite using a process termed ‘nitritation’. This process uses AOB nitrifiers. In a second step, the remaining ammonia and converted nitrite can then be utilized by anammox bacteria to oxidize ammonia to nitrogen gas, using nitrite as the electron acceptor without the need for organic carbon to provide a source of energy. The relatively recent discovery of this process has created new opportunities to remove nitrogen from wastewater at a much lower cost than traditional nitrification/denitrification since this process requires approximately 60% less oxygen, no additional carbon, and generates 80% less biosolids. One researcher has noted “mainstream deammonification is the most original idea to be promoted in the wastewater industry in over one hundred years. It is truly a paradigm shift from a scientific perspective and opens the door to an unprecedented era of sustainability, environmental protection and cost savings.”

Instead of using two of the three sets of organisms, this invention combines all three sets—nitrifiers, denitrifiers, and anammox—to treat wastewater with a wide range of carbon to nitrogen ratios by varying the amounts of each type of organism as necessary to permit useful treatment. Useful treatment occurs as the nitrifiers and denitrifiers remove both ammonia and organic carbon with the carbon serving as an energy source; while deammonification with anammox removes ammonia without requiring carbon as an energy source. Adjusting the nitrification, denitrification, deammonification ratio appropriately depending on the amount of organic carbon and ammonia will permit a high degree of removal of both carbon and nitrogen without the need to add additional organic carbon. This process is an invention termed concurrent Nitrification/Denitrification/Deammonification (NDD).

Controlling the NDD Ratio

To achieve effective treatment of wastewater containing high levels of organic carbon and nitrogen, the NDD ratio must be controlled. This is necessary for starting up a system and establishing effective treatment as well as for continuing operation of a system. The three major requirements to properly control the NDD ratio are:
1) Achieving the correct balance of organisms,
2) Accommodating the different microenvironments these organisms require
3) Adjusting for the extremely slow growth rate of anammox bacteria.

Achieving the Correct Balance of Organisms

NDD can remove high levels of organic carbon and ammonia if the proper balance of organisms necessary to effectively treat a wastewater's particular ratio of carbon to ammonia is attained. Removal of ammonia by SND requires a high carbon to nitrogen ratio while removal of ammonia using deammonification can proceed with a very low carbon to nitrogen ratio.

For example, recent research using a membrane aerated biological reactor (MABR) reactor treating ersatz Early Planetary Base (EPB) wastewater indicates that the amount of carbon in EPB wastewater is sufficient to permit approximately 44% of the nitrogen to be removed by nitrification/denitrification. This would indicate that the balance the Nitritation-Deammonification and the Nitrification-Denitrification processes should have a ratio of between the 40%-60% and the 60%-40% range to ensure adequate, balanced removal of both organic carbon and ammonia.

Accommodating the Different Microenvironments of Organisms

Controlling microenvironments is also necessary to ensure the proper mix of organisms. Nitrifiers (both AOBs and NOBs) require aerobic environments while denitrifiers and anammox require anoxic (i.e. no free oxygen present but oxygen bound as nitrite and nitrate may be present) environments. Thus management of oxygen levels within a system may help promote the growth of one type of organism and restrict the growth of another. These organisms also have differential growth rates that vary according to temperature and pH and these are two other parameters that are varied to achieve the proper mixture of organisms.

Adjusting for the Slow Growth of Anammox

A third factor that must be addressed to ensure correct application of deammonification is accommodation for the slow growth of anammox. Mixed processes which use slow growing organisms require use of attached growth biofilms to prevent washouts of organisms and this is especially essential for slow growing anammox bacteria which have doubling rates 5-10 times longer than nitrifiers. This permits anammox to be retained and/or recycled without undue loss. This factor is especially important with respect to starting up a system since the extremely slow growth rate of anammox can extend system startup to between several months to a year. Start up time has been reduced to as little as 50 days by seeding a treatment system from another operational treatment plant.

Balancing the NDD process involves finding the optimal mix of organisms shown in FIG. 1 and this mix will vary depending on the absolute and relative concentrations of organic carbon and nitrogen in the wastewater.

### 7.1.1 Results of Operation of NDD Wastewater Treatment System

NDD wastewater treatment system reactors were operated using an inoculum nitrifiers, denitrifiers, and anammox to remove high levels of organic carbon and nitrogen. The inoculum was also tested to demonstrate its ability to rapidly start a treatment system. The operation of the reactors focused on the following three specific objectives:

1) Preparation of Bacterial Cultures and Construction of Reactors
a) Obtain bacterial cultures with an appropriate mixture of AOB, NOB, denitrifiers and anammox
b) Lyophilize (freeze dry) bacterial cultures
c) Construct and prepare four reactors for testing of inocula

2) Operate Reactors and Collect Data
a) Operate two reactors to induce dormancy, store at room temperature for an extended period of time, and reactivate the organisms to treat wastewater.
b) Operate four reactors using lyophilized organisms that can be rapidly reactivated to treat wastewater.

3) Analyze Data to Verify Success and Determine Operating Parameters
a) Analyze reactor data collected from operation of the reactors to verify substantial (in the rang of 85%) removal of organic carbon and ammonia
b) Determine operating parameters

### Task 1: Preparation of Bacterial Cultures and Construction of Reactors

Bacterial Cultures were Obtained as Follows:

Anammox—The strain of anammox used was Candidatus Brocadia Caroliniensis, having Accession Deposit Number NRRL B-50286.

Nitrifiers—This culture has been maintained for fifteen years (accession number NRRL B-50298).

Denitrifiers—Denitrifiers were obtained from a local wastewater treatment plant.

The cultures used in Reactors 1 and 2 (R1, R2) were live organisms that were acclimated to the reactors and then treated to induce dormancy for 45 days. During the 45 day dormancy period the organisms were stored in sealed containers filled with inorganic media containing 5 mM each of NH4 and NO2. In addition, NO3 (5.7 mM) and sodium molybdate (3 mM) were added as a redox buffer and an inhibitor of microbial sulfate reduction, respectively.

Reactors 3, 4, 5, and 6 (R3, R4, R5, R6) received lyophilized organisms that had been reactivated. The organisms were separately lyophilized in accordance with treatment 5B described in Dr. Rothrock and Dr. Vanotti's paper on lyophilization of anammox bacteria [Rothrock M J, Vanotti M B, Szögi A A, Gonzalez M C G, Fujii T. Long-term preservation of anammox bacteria. Applied Microbiology and Biotechnology. 2011;92(1): 147-157]. This procedure uses skim milk as a cryoprotectant and initial pre-freezing of the organisms to −200 C in liquid nitrogen as preparation for lyophilization. R3 and R4 received lyophilized organisms that had been stored lyophilized for 10days while reactors 5 and 6 were started later and used lyophilized organisms that were stored for 60 days. The data indicate that the time of storage did not significantly affect the performance of the reactivated the organisms.

At any one time, two to four reactors were in service. The reactors had a capacity of 14 liters and are schematically illustrated in FIG. 4 and were identically equipped as follows:
Two small mixers to keep a thin layer of active biofilms on the outside of scaffolds and disperse all additives including organisms, influent feed, and air added for aeration. These pumps maintained relatively homogenous conditions in the tanks and quickly and evenly dispersed additives. A dye test was performed to evaluate mixing and visually confirmed homogeneity within ten seconds.
Two small aerator pumps, two fine bubble aeration stones, and throttling valves to provide air as necessary. The aeration system could be controlled automatically and manually based on pH, ORP, dissolved oxygen, or by timer. All of these methods were used at times during operation and were found to have various strengths and drawbacks.
One heater with a thermostat to automatically maintain the desired temperature. A second thermostat capable of remote adjustment was also used to provide redundancy and flexibility.

Each reactor contained two scaffolds constructed of Poret foam that is used in Integrated Fixed-film Activated Sludge (IFAS) systems. This type of foam has an extremely high surface area of more than 1,000 m²/m³. Each scaffold had four layers of foam comprised of two inner layers each 25 mm wide and two outer layers each 12.5 mm wide. A cotton gauze pad was inserted between each layer to help retain embedded organisms and this gauze was also inserted in scaffolds that did not receive embedment.

Both reactors used identically constructed scaffolds, however, the first reactor in each pair (R1, R3, and R5) did not have the organisms embedded in the scaffolds while the second reactor (R2, R4, and R6) did receive scaffolds with organisms embedded as shown above. Overall dimensions of each scaffold were 125 mm×125 mm×75 mm.

The reactors received Early Planetary Base (EPB) wastewater formulated in accordance with the ersatz formulation in advanced life support baseline values and assumptions document [Hanford (Editor). Advanced life support baseline values and assumptions document. NASA publication NASA/CR-2004-20894. 1Aug. 2004]. The reactors were initially filled with 50% strength EPB. Once the organisms had degraded 50% of the initial ammonia the reactor began to receive half strength wastewater on a continuous basis. Full strength wastewater started to be fed once treatment was established, which varied between 9 and 16 days of operation depending on the reactor. Effluent was manually removed on a daily basis and was analyzed unfiltered.

The reactors were equipped to continuously monitor temperature, pH, ORP, and conductivity. Dissolved oxygen was monitored on a daily basis except during the 15 day feasibility testing when it was monitored continuously.

During the 15 day test periods the dissolved oxygen level was monitored continuously using in-situ optical dissolved oxygen probes. Samples were collected on a daily basis and tested immediately for ammonia, nitrate, and nitrite by personnel operating the reactors using bench top colorimetric tests. These samples were used in conjunction with pH and dissolved oxygen levels for daily process control.

Additional daily samples were collected for more detailed analysis and analyzed to determine influent and effluent levels of ammonia, nitrate, nitrite, and COD. Inorganic nitrogen concentrations were measured using an auto-analyzer (Technicon Instruments Corp., Tarrytown, N.Y.): NH4-N was determined by the automated phenate method (4500-NH3 G), NO2-N+NO3-N were determined by the automated cadmium reduction method (4500-NO3-F), and NO2-N alone was determined by applying the same colorimetric method without the cadmium reduction step. NO3-N was then calculated by subtraction.

The reactors were monitored continuously via the Internet and readings were collected and stored at 10-minute intervals for temperature, pH, ORP, conductivity, and power usage. Pumps and other equipment could be started, stopped, and reprogrammed remotely. Software also permitted remote control of temperature, air feed, and reactor influent feed.

### Task 2: Operate Reactors and Collect Data

Operation of Reactors 1 and 2 (Live Organisms with Induced Dormancy and Reactivation)

The live cultures were used to inoculate R1 and R2, filled with 50% EPB. The reactors were then operated to acclimate the microbes prior to inducing dormancy for 47 days. During the 47 day dormancy period the organisms were stored in sealed containers in inorganic media containing 5 mM each of NH4 and NO2. In addition, NO3 (5.7 mM) and sodium molybdate (3 mM) were added as a redox buffer and an inhibitor of microbial sulfate reduction, respectively. After this time period the scaffolds were reinserted into reactors filled with 50% EPB and reactivated.

R1 and R2 were identical except for the method used to add the organisms to the reactors. Reactor 1 had organisms added into the reactor and dispersed in the reactor process wastewater (50% EPB). R2 had organisms inserted inside the scaffolds. This was done to determine if there might be an advantage to embedment of the organisms.

The different modes of addition made a significant impact on the appearance of the reactors. R1 receiving non-embedded organisms was cloudier and a noticeable biofilm was observed on the scaffolds. R2 was significantly clearer and the biofilm was not very visible (i.e. it was either present internally in the scaffold or the outer biofilm was not as noticeable as in R1).

During dormancy a small amount of gassing was noted in the containers and was released through the water seal. Except for the small amount of gassing observed there were no other visually apparent changes in the scaffolds during storage. After 47 days the scaffolds were rinsed once with distilled water and reinserted in the reactors which were filled with a solution of 50% EPB. Steady state operation was established 19 days after reinsertion and subsequently successfully completed final 15 day feasibility testing.

Operation of Reactors 3 and 4 (Lyophilized Organisms)

R3 and R4 were started using lyophilized organisms . Each of the three sets of the lyophilized organisms was reconstituted by mixing in one liter of distilled water. Once mixed, the contents of the flask were decanted to remove the cryoprotectant (skim milk) that had dissolved in the water). Loss of organisms in the decanted water was limited by filtering the decanted water a 140-mesh filter to retain organisms. This process was repeated twice to maximize the removal of cryoprotectant. Skim milk left over in the culture was not toxic, however, it exerts a large organic load that later appeared detrimental to start up of the reactors.

Once the organisms were reconstituted, one set was added directly to R and dispersed into the reactor process wastewater (50% EPB).

The second set of reconstituted organisms were embedded in the four layer scaffolds with the anoxic denitrifiers and anammox embedded in the middle (between the two innermost layers) and the aerobic organisms embedded further outward (between an outer layer and an inner layer). Once the organisms were embedded the mesh was enclosed in the cage and inserted into R4 that had been filled with 50% EPB.

R3 and R4 had a similar appearance to the corresponding R1 and R2. R1 and R3, which received organisms added directly to the wastewater, had a more cloudy appearance and biofilm growth was much more evident that in R2 and R4.

Operation of Reactors 5 and 6 (Lyophilized Organisms)

R5 and R6 were started using organisms that had been lyophilized 60 days earlier. The reactivation process was similar to that used for R3 and R4 with the exception that the skim milk used as a cryoprotectant was not as thoroughly removed. Two total rinses to remove cryoprotectant were performed instead of the three total rinses performed for R3 and R4. This was to assess the necessary degree of removal of cryoprotectant to ensure good reactivation. It quickly became apparent that a high degree of cryoprotectant removal is necessary to ensure good reactivation. Both reactors had difficulties, however, R5 was significantly worst than R6. The better results from R6 may be due to the embedment of organisms in the scaffold and the discarded liquid that seeped through the scaffolds. In both cases the COD was significantly higher than in R3 and R4. While R3 and R4 had an initial COD of approximately 2,000 and 1,200 mg/l of initial COD, R5 and R6 had approximately 12,000 and 1,400 mg/l respectively. The six to ten fold increase in COD in R5 had significant negative consequences. Although the tank was aerated at high levels for two weeks it was unable to maintain dissolved oxygen. Additionally, the pH dropped as low as 3.7 and remained in the range of 5.0 for several days. Additionally, the ammonia concentration in the reactor more than doubled from approximately 300 to 650 mg/l, indicating that the skim milk proteins were being broken down into ammonia and other constituents.

After ten days R5 began to recover and by 17 days it had recovered sufficiently to begin feeding EPB. Twenty-five days after R5 was seeded with reactivated lyophilized organisms it was removing almost 80% of the ammonia and 75% of the COD, which is indicative of a very robust set of organisms. R6 also had a slower start than R3 and R4, however, the problem was not as severe and recovery was more rapid resulting in R6 meeting both the ammonia and organic carbon removal goals.

Task 3: Analysis of Data and Preliminary Phase II planning

Reactors 1 and 2, with Live Organism

R1 and R2 initially received live organisms and once a biofilm was established, dormancy was induced for 47 days. After this time the reactors were tested to determine the effects of dormancy. Both reactors exceeded feasibility criteria for post dormancy ammonia removal/transformation, organic carbon removal, and startup time.

Nitrogen Removal/Rransformation.

Removal/transformation of ammonia in both reactors also exceeded the 85% goal during the post-dormancy performance test period, demonstrating 95% and 94% N removal/transformation in R1 and R2, respectively.

Initial Startup—Both R1 and R2 showed a measurable reduction of NH4+ by the Day 6 sample, suggesting that the live organisms suffered little to no effects during the transition from the source reactor to these reactors. Onset of NH4+ removal in R1 appeared to begin sooner (by Day 2 or 3) than in R2 (evident on Day 6), possibly due to substrate mass transfer/transport limitations associated with the biomass being embedded within scaffolds in R2. Regardless, both reactors reduced the initial quantity of NH4+-N in the reactor plus N added via half-strength feeding and attained nitrogen removal/transformation steady state within 14 days. While receiving full-strength EPB feed over the period from Day 22-29, R1 and R2 achieved NH4+ removals of 84.5% and 80.8%, respectively.

Post-Dormancy Startup—Both reactors achieved deammonification rapidly after re-start, evidenced by the immediate decline in ammonium. Both reactors started exceeding removal goals 19 days after being removed from the 47 day dormancy period. While receiving full-strength EPB during the steady state performance test period from Day 96-110, both reactors well exceeded the N removal/transformation performance goal by averaging 94-96% NH4+ removal relative to the feed concentration. Additionally, the percent removal/transformation averaged 95% removal (as gas) and 5% transformation (as nitrite/nitrate).

Organic Carbon Removal.

Removal of organic carbon (as measured by COD) in both reactors also exceeded the 85% goal during the performance test period, exceeding the 85% goal when removed from dormancy, achieving 92% and 88% COD removal in R1 and R2, respectively.

Initial Startup—Both reactors exhibited similar trends of rapidly-declining COD over the first few weeks. No readily biodegradable substrate was present in the dormancy media, and COD concentrations remained low and even dropped further during the 47-day dormant period.

Post-Dormancy Startup—Post-dormancy, both reactors maintained low COD concentrations throughout the remainder of the study during periods of both half and full-strength COD feeding. Slight upward trends in COD in the final 15 days could be an indication of buildup of refractory organics but could also be a result of less oxidized nitrogen available for heterotrophic denitrification. The latter could occur if anammox bacteria were more competitive post-dormancy and were outcompeting facultative heterotrophs for nitrite. This could not be confirmed or tested due to the limited time available in the Phase I study.

Observations pertaining to R1 and R2

Nitrite Observations—Effluent NO3− was near or below detection limits, but nitrite accumulated in both reactors before and after dormancy. The nitrite subsided in R1 prior to dormancy by controlling the length of the unaerated portion of the reactor cycles. In this manner of aerating to stimulate nitritation of ammonium to nitrite, followed by restricting aeration to allow denitritation and anammox removal of nitrite, reactor operation was able to be balanced. In the case of R2, the ˜100 mg/L of NO2− present just prior to dormancy likely served as an additional redox buffer and anammox maintenance substrate during dormancy. In other words, the anammox microbial community may have actually benefitted from a controlled anaerobic dormancy period replete with substrate. After emerging from dormancy, both reactors experienced a brief nitrite spike followed by a concurrent reduction in both ammonium and nitrite at the same time. This signature simultaneous reduction in both forms of N has been observed by others and is strong evidence of establishment of a robust anammox community and associated activity. This observation, occurring after dormancy, supports the idea that a dormancy period containing both ammonium, nitrite, and nitrate may enrich anammox bacteria and shorten the time to achieve the targeted N removal. Nitrite and nitrate present in the dormancy medium were nearly (R1) or completely (R2) consumed over 47 days suggesting that periodic adjustments of these nutrients may be necessary to successfully extend dormancy beyond this time period.

Contribution of Anammox—Examining the stoichiometry of nitrogen removal and COD removal, it is possible to begin to infer the microbial communities active in the reactors. If the changes in concentrations are considered representative of mass removals for each day, the ratio of mass of COD removed to mass of N lost from the system (defined as the reduction in NH4+ minus the remaining effluent NO2− and NO3−) can be calculated and compared to the stoichiometry for heterotrophic denitrification alone. The average ratio of COD consumed to N lost for the 15-day performance test period was 1.46 mg COD removed per mg N lost from R1, and the same ratio was 1.40 for R2. These are well below, approximately half of the stoichiometric minimum of 2.86 mg COD required per mg N denitrified. This observation suggests that another mechanism for N removal in addition to nitrification/denitrification was active in the reactors and underscores the critical role that an effective anammox community can play in treating this wastewater.

Feed and Operation Notes: In both R1 and R2, influent NH4+ data and COD data are the same, because both reactors were fed from a common pump controller and feed stock (the same is generally true for all subsequent reactor pairs, 3-4, and 5-6). Some loss of ammonia in the feed occurred during feed cycles, as is evident during periods D and E, possibly due to volatilization. However, percent removals were always calculated based on the actual influent NH4+ concentrations so as to take into account influent variability. Oxidized N (NO2− and NO3−) was always below 2 mg/L in all feed samples for all six reactors. Hence, influent NO2− and NO3− are not shown in the graphs.

Summary of Reactors 1 and 2 Results:

R1 and R2 Results Suggest That:
The mixed inoculum used in this study was hardy enough to survive brief transit and successfully inoculate reactors treating EPB.
The mixed inoculum could survive and reactivate after a dormancy period of 47 days in a redox-buffered medium, exceeding 94% NH4+ removal and 88% COD removal.
The benefits of embedding the mixed inoculum into the foam scaffolding are undetermined, as performance was very comparable between the two reactors.
The mixed inoculum contained a diverse enough community to achieve nitrification, denitrification, and anaerobic ammonium oxidation, supported by stoichiometric observations.
Dormancy in the presence of a medium amenable to anammox activity may provide a competitive advantage for these slow-growing but important members of the mixed inoculum.

Reactors 3 and 4, with Lyophilized Organism Inoculation

R3 and R4 received reconstituted lyophilized organism with the organisms added directly to the wastewater for R3 and embedded in scaffolds in R4.

Nitrogen Removal/Transformation.

R3 and R4 exhibited reduction in ammonium approximately 12 days after startup and continued to nitrify after feeding was begun on Day 16(R3) or Day 14 (R4). Ammonium removal was incomplete with effluent concentrations ranging from 90 to 150 mg/L-N in both reactors, but these concentrations were similar to those observed in R1 and R2 suggesting the lyophilized organisms were successfully reconstituted and became active rapidly. NO2− accumulation was observed to begin around 20 days into operation or 4-6 days after feeding commenced. Because this was also observed in R1 and R2, it does not appear this was an effect of lyophilization, nor did it appear to inhibit growth of any of the microbial communities active in N metabolism. After Day 30 of operation, the gradual decrease in NO2− and increase in effluent NH4+ is a result of process control by reducing the aeration periods. Throughout the study adjustment of aeration cycles was effective as a process control measure for balancing nitrification with denitrification/anammox.

Increasing the feed loading to full-strength EPB led to more stable operation and lower concentrations of both ammonium and nitrite in both reactors. Higher loading has been shown by others to help limit available DO in reactors with anammox communities, leading to better autotrophic nitrogen removal, and this could be the mechanism observed in these two reactors. During the 15-day performance test periods, NH4+ removal averaged 87.6% and 92.6% in R3 and R4, respectively, exceeding the 85% removal goal.

Organic Carbon Removal.

As described previously, a cryoprotectant is added during lyophilization of the inoculum to prevent damage to cellular membranes and maximize cell viability during reactivation. The cryoprotectant used in this work was skim milk, at very high ratios of milk to biomass. As described previously, care was taken during reconstitution to remove as much of the residual cryoprotectant as possible prior to reactor inoculation. However, evidence of residual cryoprotectant was visible in the COD removal performance data. Initial concentrations were measured between 1,600 and 2,000 mg/L of COD regardless of whether the inoculum was added to the bulk liquid (R3) or embedded in the scaffolding (R4). Both reactors recovered quickly to effluent COD concentrations below 200 mg/l within 10 days of startup and ultimately reached high removal percentages of 79% (R3) and 82% (R4), just below the goal of 85%. Interestingly, COD removals never matched those observed in R1 and R2. This could be due to effects of lyophilization or residual components of the media such as cryoprotectant, for which reason optimization of lyophilization and cryoprotection is a key focus of our Phase II proposal.

Observations Pertaining to R3 and R4

As with R1 and R2, examination of the observed stoichiometry can provide insight into the microbial metabolisms occurring the reactors. Both reactors had an average COD_{removed}:Nₗₒₛₜ ratio of 1.3, again far below the theoretical stoichiometric requirement of 2.86 g COD:g N denitrified. This suggests that anammox was a significant contributor to the nitrogen removal performance of the reactors.

These Results with R3 and R4 Suggest That:
The mixed inoculum could be lyophilized and successfully reactivated to treat EPB to high % removals of nitrogen.
Process control in the form of adjusting the aeration cycle duration could effectively balance ammonia oxidation with denitrification/anammox.
Increasing the influent loading appeared to result in more stable operation, possibly due to establishing more DO-limited conditions beneficial to denitrifiers and anammox.
The benefits of embedding the mixed inoculum into the foam scaffolding are undetermined, as performance was very comparable between the two reactors.
Insufficient rinsing of inocula lyophilized with the current cryoprotectant (skim milk) may cause high initial COD concentrations. Although the reactors generally recovered well, COD removal was more variable and narrowly missed removal goals, emphasizing the need to reevaluate lyophilization/cryoprotectant methods in Phase II.

Reactors 5 and 6, Inoculated with Lyophilized Organisms.

R5 and R6 received reconstituted lyophilized organism with the organisms added directly to the wastewater for R5 and embedded in scaffolds in R6.

Nitrogen Removal/Transformation.

R5 and R6 were also started with previously-lyophilized organisms. During the reactivation process for R5, the volume of media used to rinse the cryoprotectant from the biomass was insufficient, resulting in leftover cryoprotectant (skim milk) and extremely high COD concentrations in the bulk liquid and the effluent. The impact on nitrogen removal can be seen in the large increase in ammonia in the reactor contents/effluent despite the lack of feed during Days 1-17. Hydrolysis and ammonification from the proteins in the milk resulted in ammonia concentrations exceeding 600 mg/L. However, the reactor responded with a rapid reduction in NH4+ to less than 100 mg/L-N by Day 17 and no increase in NO2−/NO3−. Hence, a robust population of nitrifiers were present along with just as hardy communities of denitrifiers, anammox, or both. In R6, the inoculum was well-rinsed and exhibited what is considered to be more representative of the expected startup behavior, with the initial NH4+ being reduced by half in approximately 10 days. Initiation of feeding (RS-Day 17; R6-Day 9) was received differently by the reactors: R5 saw an increase in effluent NH4+, while R6 continued to improve with lower effluent NH4+. This is possibly due to oxygen limitation in R5, in which the COD was approximately twice the COD in R6 when feeding was initiated. Hence, there was greater competition for oxygen between nitrifiers and autotrophs in R5 than in R6. This initial perturbation of high cryoprotectant COD and ammonia may have been the reason R5 was the only reactor of the six that did not meet the NH4+ removal goal of 85%. Unlike R1 and R2, a characteristic signature of anammox was not observed during operation (simultaneous decline in NH4+ and NO2−). However, it is not unusual for onset of anammox to occur more than 30 days after startup, and these two reactors had insufficient time for this to occur due to the limited duration of the Phase I schedule. In summary, however, R6 achieved the 85% removal goal and a rapid startup, while R5 revealed lessons about the importance of lyophilized culture reconstitution.

Organic Carbon Removal.

As described above, the residual cryoprotectant in R5 that resulted from insufficient washing created extremely high COD concentrations (12,000 mg/L). However, it is noteworthy that even under this scenario, which could be considered a major process upset, the concentration of COD had decreased by 96% to less than 400 mg/L within 16 days of startup. After initiation of feeding, effluent COD concentrations remained below 200 mg/L, were very stable, and exhibited no sign of increasing during the performance test period. Concentrations of COD in R6 were more similar to those observed in R1 and R2, which were inoculated with live liquid-phase cultures that had not previously been lyophilized. The similarity in startup performance between R6 and R1/R2 support the feasibility of using lyophilized organisms as a comparable substitute for liquid-phase cultures contained in water, which have a higher ESM from the standpoint of launch impacts.

Observations Pertaining to R5 and R6

Reactor stoichiometry during the 15-day performance test period shows that R5 exhibited a COD_{removed}:Nₗₒₛₜ ratio of 1.80, much higher than the previous reactors 1-4. This could be due to a higher fraction of oxidized nitrogen going to heterotrophic denitrification than to anammox (due to the short time duration of operation, in which anammox may have been yet to emerge). Or, it is possible that the successful competition of heterotrophs with nitrifiers for oxygen may have led to a greater fraction of COD being removed by aerobic oxidation. Indeed, between Day 7 and Day 16 in R5, the slope of the line of COD v. time is 16 times greater than the slope of NH4+ v. time. Or, the ratio of COD_{removed} to Nₗₒₛₜ was 16:1, or more than enough to facilitate denitrification of all the NO2− and NO3− produced by nitrifiers, with COD left over to spare for aerobic oxidation. The COD:N ratio for R6 was 1.67, between that observed in R5 and the other reactors. Anammox metabolism is still likely, given how much lower this ratio is than is theoretically required for heterotrophic denitrification.

These results with R5 and R6 Suggest That:
Mixed lyophilized inoculum could be successfully reactivated to achieve EPB treatment performance (>85% removal of both N and COD) similar to that observed by inoculating with live cultures (R1/R2).
Insufficient removal of lyophilization solution/cryoprotectant has implications for both COD loading and N loading. However, the mixed inoculum successfully recovered from the initial process upset within 17 days.
The benefits of embedding the mixed inoculum into the foam scaffolding are undetermined. Because of the process upset to R5 it was not possible to attribute any differences in performance to embedment or bulk liquid addition.

Summary of Results

Phase I SBIR research has confirmed the feasibility of developing an inoculum that can be used to rapidly and reliably start up a wastewater treatment system capable of removing high levels of nitrogen and organic carbon.
Overall, 5 of the 6 reactors removed more than 85% ammonia, 3 of the 6 reactors removed more than 85% of COD, and all reactors achieved steady state in less than the target time of 45 days.
The desired combination of organisms and treatment levels can be achieved through control of a few basic parameters including pH, temperature, DO, and on/off cycling of oxygen. These parameters can be used to control NH₄, NO₃, and NO₂ levels and shift the balance and activity of the organisms. Due to the short time the reactors were operated, an operating strategy for different conditions was not developed but this will be a Phase II priority.

### 7.1.2 Summary of Novel Aspect of NDD Invention

There are a number of novel and unexpected aspects that are claimed as part of this invention including the following:
1. Growth of and treatment with NDD in a reactor is enhanced by the novel use of fixed biofilm structures which permits a more permanent biome to form which provides better treatment than randomly mixed media.
2. Treatment is enhanced by complete mixing of contents without undue shearing and agitation such that there is substantially the same conditions through.
3. A minimal amount of dissolved oxygen is necessary to achieve substantial treatment and high levels of oxygen are not desirable unless it is necessary to address a special situation such as stimulating the growth of nitrifiers or converting high levels of inhibitory nitrite to nitrate which is less inhibitory of anammox. Target oxygen levels can be set below 1.0 mg/l and generally maintained at 0.6 mg/l or lower. Periods of no oxygen are also desirable and one target set of dissolved oxygen/no dissolved oxygen is 10%-20% of time with dissolved oxygen and the balance without dissolved oxygen. This provides more anoxic time for the slower acting denitrifiers and anammox to be active.
4. Treatment can be improved by maintaining an optimum pH which is generally over 7.0 and preferably in the range of 7.5 to 8.5. This also provided suitable alkalinity for the process to operate correctly. High pH's of over 9 are not desirable. An innovative feature of later testing of the bioreactor used granular magnesium carbonate to maintain a steady pH in the range of 8.3 to 8.5 which promoted enhanced treatment results. Use of a slow release form of pH and alkalinity to enhance treatment is a specific claimed novel aspect of this invention. Alkalinity and pH can also be adjusted by addition of a base, or if the pH requires reduction by the addition of an acid. Lack of sufficient alkalinity is a major cause of failure for nitrification/denitrification systems for septic tanks and the use of slow release pH/alkalinity adjustment material may overcome this issue and is a claimed invention for nitrification/denitrification systems in addition to the NDD process.
5. Treatment can be improved by maintaining an elevated temperature in the range of 26 to 34 degrees C. and preferably in the range of 28 to 30 degrees C. While it is desirable to maintain the temperature of the entire process a novel claimed aspect of this invention is maintenance of temperature of the media and scaffolds the biofilm is supported by. This has the advantage of stimulating the activity of the less active denitrifiers and anammox since they are nearest the media. Thus this technique can also be used to stimulate their growth to overcome an imbalance caused by too many nitrifiers. This technique can also be achieved at a significantly lower energy cost than heating of the entire contents of a system. Additionally, this technique can be enhanced by the use of thermally conductive media. Media may also be heated by the use of active or passive solar or geothermal energy.
6. A control scheme to correct for high levels of inhibitory nitrite by increasing oxygen levels to covert nitrite to nitrate and using denitrifiers to reduce this further to nitrogen gas. This cannot be done in normal deammonification since denitrifiers are present, however, this novel control scheme works well for NDD. Optionally, added organic carbon could be fed for a short period of time to enhance denitrification and/or influent feed could be reduced or stopped for a period of time to permit nitrogen to be fully removed by the denitrifiers without creating new nitrites from influent ammonia.
7. During testing of the six reactors described above, a very fine grained ‘fog’ of suspended solids was noted in the liquid that surrounded the scaffolds. The suspended solids appeared to enhance treatment and were probably suspended nitrifiers and aerobic denitrifiers which augmented the nitrifiers and denitrifiers on the biofilm. Evidence of the presence of suspended aerobic nitrifiers included reduced nitrate and nitrate levels in samples taken when this ‘fog’ was present that were stored for several days before before being sent offsite. These samples often came back with zero nitrite and nitrate while the same sample lot had nitrite and nitrate when tested immediately. This even dispersion probably reduced oxygen consumption and also enhanced treatment and is a claimed feature of NDD treatment invention using fixed scaffolds.
8. Use of a standardized set of organisms to successfully implement NDD is also a novel feature of this invention. In particular the use of a monoculture of anammox organisms is a feature of this invention

### 7.2 Description of Patterned Fixed-Film Treatment (PFT)

FIG. 5 is a schematic side view of a Patterned Fixed-film Treatment (FTS) system. Influent (0510) flow can be even distributed (0512) along the top of the system. In a variant it could be added in one location of there was good mixing of the entire system or it could be added in multiple locations in addition to the top if desired. There could be a multiplicity of points to add gases such as oxygen and liquids or to take samples (0514) and these points could have separate controls (0516) to permit adjustment of local conditions. Instruments could be embedded at multiple points (0518) to permit more precise control of local points in the system. Effluent can be withdrawn from multiple points (0520) along the bottom of the reactor and can be recycled as desired. This system could be combined with variable submerged treatment (discussed below and shown in FIG. 6) to vary conditions at points in the reactor.

Patterned treatment using a substantially ordered and structured environment to enhance wastewater treatment. Generally, the pattern is applied over a large area and may incorporate a number of features. In these instances, certain characteristics are included such as the use of structured media to permit the growth of a stable biome and substantially complete mixing to permit substantially uniform growth and treatment. Additional items can include multiple addition and/or withdrawal points to more precisely control various biomes and treatment characteristics. A key feature of patterned treatment is an ordered structure that permits enhanced control of the environment and process due to the presence of the patterned structure.

Patterned treatment may at times have substantially ordered but varied environments. For example, the overall pattern may be retained for a system but certain items, such as oxygen, could be added in one part of the process but not in another. This permits flexibility to tailor the system to have multiple structured biomes which can enhance treatment. Patterned treatment can also be combined with variable submerged treatment discussed below to further enhance treatment.

Patterned treatment can be combined with NDD and Variable Submerged Treatment (discussed below) to further optimize treatment. A PFT system was used for all six reactors tested and described in section 7.1 above.

### 7.3 Description of Variable Submerged Treatment (VST):

Variable submerged treatment is the alteration of the ratio of media submerged in liquid and in gas to enhance treatment. VST permits the environmental conditions of biomes to be changed to tailor the exact amount of treatment provided at different locations. For example, the ratio of submergence could be changed from zero submergence to 50% submergence to permit biomes in the submerged portion to have greater access to food. A 50% submergence could be couple with a high oxygen gaseous environment to permit nitrification in a the non-submerged portion and the submerged portion could have a zero dissolved oxygen level to permit enhanced denitrification and deammonification. VST can also be used to better control other variables including temperature.

### 7.4 Description of Septic Tank and Other Treatment Systems

The invention treats and removes organics and nutrients by primarily biological treatment, although chemical and physical treatments are included in some alternatives. The process works as follows:
Flow from the septic tank enters the conditioning element where the characteristics of the flow are altered to make influent more easily treatable. Generally, the flow is conditioned by use of pH adjustment and/or buffering, the temperature is adjusted, and the flow is equalized, mixed, and evenly dispersed to the treatment. The conditioning element will be of sufficient size to equalize flows somewhat and also to contain the conditioning element such as calcite filter media for pH adjustment and alkalinity addition. Small immersion heaters will generally provide heat but a jacketed heater or some additional means could also heat the flow. The conditioning element will also generally have a method to add essential micronutrients such as the use of slow release resin pellets containing these micronutrients.
Flow will then enter the treatment element where organics and nutrients will be removed by organisms that are cultured on media that prevents them from being washed out of the unit. The media may be similar to that used in trickling filters or it may comprise multiple individual units similar to that used in packed towers. The organisms will generally consist of a combination of nitrifiers, denitrifiers, and anammox organisms. However, if only nitrogen removal is desired the unit could have only nitrifiers and anammox. This later combination would generate fewer solids to dispose of but also is a lower level of treatment. The mixture of organisms would be highly standardized to ensure reliable treatment. The oxic condition of the tank would be carefully controlled to permit sufficient oxygen for aerobic organisms but it would be low enough to permit anoxic and anaerobic organisms to grow in the biofilm that is closest to the media and contains no free oxygen. The optimum ratio of the organisms will be controlled by varying the level of oxygen introduced and by altering pH and temperature in a manner that favors the growth of one organism over another whenever the ratio of organisms is out of balance. An integral solids separation process may remove solids produced by the treatment element to prevent them from entering the effluent. An instrumentation and control system would be employed for both elements and would be able to control the addition of oxygen and maintain desired parameters as well as transmitting information remotely for monitoring and control.
The novel add-on unit for septic tanks also includes several unique benefits with respect to operation and maintenance of the system including the following:
   A conditioning tank that can be sized to contain sufficient pH/alkalinity adjustment material for a year or more. This permits stable long term operation with infrequent maintenance requirements
   A standardized ‘biological core’ element that can be replaced or upgraded as necessary. The system would have a scaffold system that can be easily pulled and replaced if the organisms were not functioning properly or if an upgraded mix of organisms were available. Service representatives could carry spare ‘biological cores’ and replace them as necessary during periodic inspection service visits.

Description of Integrated Septic Tank Unit

An integrated unit would have the features of both a septic tank (settling and sludge storage) and those of the add-on unit. Advantages over add-on unit include the ability to integrate the units together thus saving space and energy. For example, the solids generation from the ‘add-on’ portion of the unit could be routed by gravity to the other solids instead of requiring pumping. An integrated unit also provides opportunity for additional flow conditioning in the ‘septic tank’ portion. Good design can promote flow equalization and use of the tankage to level out undesirable spikes. The solids collection unit can also be used to generate usable methane gas.

Description of Treatment System for Small Plants

This system can also be used as a prepackaged system to treat all WW or as an add on polishing unit. The use of fixed media permits precise control of what organisms are in different microenvironments as apposed to media that are mixed by induced turbulence. The control of air and/or oxygen introduced into non-submerged fixed media filter to select for desired organism mix and to precisely control amount of oxygen present on the outer, middle, and inner biofilm. The system could have control of inlet(s) and/or outlet(s) for air and/or oxygen ventilation to maintain desired oxygen levels and control of induction of air and/or oxygen into wastewater and/or recycle stream to control how much oxygen is added to system. Oxygen addition could be steady, could vary, and/or could be intermittent

The control of the temperature in a non-submerged fixed media filter to select for desired organism mix by one of two means or a combination thereof.
Control of air temperature in non-submerged fixed media filter to precisely control temperature of the outer, middle, and inner biofilm
Control of media temperature non-submerged fixed media filter to precisely control temperature of the outer, middle, and inner biofilm
Control of wastewater temperature non-submerged fixed media filter to precisely control temperature of the outer, middle, and inner biofilm

Additionally the pH and/or alkalinity could be controlled during treatment to select for desired organism mix. Or the system could be controlled using ORP alone in conjunction with preconditioning of flow to obtain desired wastewater characteristics to permit this simplified control. Other modes of control include using a combination of DO, ORP, and/or OUR to automatically control process by automatic adjustment of temp, pH, and/or varying oxygen addition.

The unit can be operated in a ‘trickling filter mode’, ‘RBC mode’, fully submerged mode, partially submerged mode, and/or any combination thereof. Trickling filter mode being an operation in which the media is not submerged but flow is distributed over media and trickles down for treatment. RBC mode being operation where the media can rotate through the flow being treated. Additionally, an offline culture of separate major groups of organisms can be used (whether actively cultured, dormant, or lyophilized) to rebalance the system or to restock it after a process upset.

### 7.5 Description of Completely Integrated Treatment System

The completely integrated treatment system is designed to recycle a large amount of the waste it receives. In an embodiment the influent is screened for large and/or ungrindable items such as rocks, etc. and all material passing the screens is ground preferably to a ¼-in or less to prevent downstream clogging. The flow proceeds to a settling/flotation unit that is preferably anaerobic. In an embodiment, a gas without free oxygen (such as methane, CO2, and/or nitrogen) is used to float solids in additional to collection of settled solids. All solids are then sent to a digester for further treatment. Effluent from the settling/flotation unit is transferred to a nutrient recovery system, preferably one that adjusts the pH and adds chemicals as necessary to precipitate out nitrogen and phosphorus that can be reused as fertilizer. Effluent from nutrient recovery proceeds to a polishing unit which removes soluble organic carbon and unprecipitated nitrogen. This polishing unit may be an NDD process or it may be a fuel cell. Treated wastewater can them be removed by membranes or other means of solids separation. Solids removed from this process are also sent to the digester. The digester has a mixer and grinder to recirculate flow to enhance degradation. Supernatant is sent back to the head end of the plant to be retreated. Gas, which is primarily a mixture of methane and CO2 are withdrawn and a substantial amount of CO2 is removed by membrane, algal use, or other means and the remaining gas which is rich in methane is either used to power a generator or sent to a fuel cell to directly generate electricity. Key features include the grinding of solids finely, anaerobic settling/flotation, P and N recovery, polishing, and integrated use of a digester to beneficially recover a substantial amount of waste removed.

### 7.6 Description Retrofit of a System

This invention could be used to retrofit an existing treatment plant that was removing only organic carbon such that the retrofitted plant would also remove nitrogen at approximately the same cost. This could be accomplished by installing an NDD system into an existing aeration basin and using the existing air system to supply the necessary oxygen for the process. Air requirements would remain similar to that needed for removal of organic carbon. The system would need to produce nitrite for deammonification and denitrification but there would be less need for mixing and the overall dissolved oxygen level could be maintained much lower than the common level of 1 to 2 mg/l for activated sludge.

### 7.7 Description of Compact Treatment

A compact treatment system can be used in situations where space is at a premium or locations that may have problems with fluid flow and mixing such as reduced gravity conditions. There are many configurations for compact treatment and FIGS. 13 and 14 illustrate two of these configurations. FIG. 13 outlines a cubic configuration in which flat membranes and flat scaffolds alternate and every other membrane provides oxygen while the alternate membranes collect effluent. This arrangement allows for high density packing of the reactor and the dual use of membranes improves flow conditions while also minimizing clogging. The configuration is also good for induced dormancy, lyophilizing in place, and other long term storage alternatives since it permits relatively simple and even addition of substances to aid in preservation and subsequent removal of these substances. The use of multiple, individually controllable valves to each membrane provides the system with additional flexibility. FIG. 14 is a cylindrical compact system that has similar features. One advantage of this type of system overall the cubic system is that cylindrical systems can fit into piping as a container and a cylindrical shape is generally better for pressurized and vacuum conditions. Additionally, removal of circular membranes as an assembly may also be easier to accommodate.

### 7.8 Description of a Method and Means to Preserve, Store, and Reactivate Organisms and Other Substances

A method and means to preserve, store, and reactivate organisms and other substances consisting of enclosures, structures, processes, devices, appurtenances and mixtures of microbial organisms that can be used in the preservation, storage, and reactivation of organisms and/or other substances such as pharmaceuticals. The enclosures can be used to assist in preservation, can be used for storage, and/or can facilitate reactivation of the organisms or substances. The invention also includes structures, processes, devices, appurtenances, and mixtures of organisms that can also facilitate preservation, storage, and reactivation. One embodiment is the preservation of microorganisms grown on a structure and then preserved, stored, and reactivated at a later time. The organisms would be preserved on the structure using a protectant for preservation and storage. The structure and organisms would be enclosed in a semi-permeable membrane that would facilitate reactivation by permitting the protectant to be washed out of the structure/organism matrix while preserving the organisms on the structure. The semi-permeable enclosure could also be enclosed by a non-permeable enclosure and either vacuum packed or pressurized with inert gas to facilitate long term storage.

### 7.9 Description of a Complete, Prefabricated Wastewater Treatment System

The completely integrated treatment system is designed to recycle a large amount of the waste it receives. In an embodiment the influent is screened for large and/or ungrindable items such as rocks, etc. and all material passing the screens is ground preferably to a ¼-in or less to prevent downstream clogging. The flow proceeds to a settling/flotation unit that is preferably anaerobic. In an embodiment, a gas without free oxygen (such as methane, CO2, and/or nitrogen) is used to float solids in additional to collection of settled solids. All solids are then sent to a digester for further treatment. Effluent from the settling/flotation unit is transferred to a nutrient recovery system, preferably one that adjusts the pH and adds chemicals as necessary to precipitate out nitrogen and phosphorus that can be reused as fertilizer. Effluent from nutrient recovery proceeds to a polishing unit which removes soluble organic carbon and unprecipitated nitrogen. This polishing unit may be an NDD process or it may be a fuel cell. Treated wastewater can them be removed by membranes or other means of solids separation. Solids removed from this process are also sent to the digester. The digester has a mixer and grinder to recirculate flow to enhance degradation. Supernatant is sent back to the head end of the plant to be retreated. Gas, which is primarily a mixture of methane and CO2 are withdrawn and a substantial amount of CO2 is removed by membrane, algal use, or other means and the remaining gas which is rich in methane is either used to power a generator or sent to a fuel cell to directly generate electricity. Key features include the grinding of solids finely, anaerobic settling/flotation, P and N recovery, polishing, and integrated use of a digester to beneficially recover a substantial amount of waste removed.

### 7.10 Description of a Floating Treatment Structure

A treatment structure that can be used to facilitate treatment of a body of wastewater. In one embodiment the structure floats on the wastewater with part above the water surface and part below. Means are provided to promote water and air circulation. The air circulation is used to provide oxygen for aerobic organisms. The water circulation permits the wastewater to be treated as it circulates through the structure. The structure may have scaffold material that has a reticulated structure such as thermoplastic foam used in wastewater treatment (such as Porex open cell reticulated polyurethane foam). The structure may also have material that facilitates the wicking of water and the exchange of oxygen from the air. The structure may have means to ensure proper buoyancy such as integral floats. The structure may have means to promote circulation such a pump or aerator. The structure may have means to periodically be flushed to prevent clogging. The structure may have means to shield sunlight from the surface to mitigate the growth of algae.

### 7.11 Description of Invention Directed to a Degassing Pump

A pump that uses a gas permeable membrane to move fluid while also removing gas from the fluid. One embodiment of the pump would be a diaphragm pump with the diaphragm composed either partially or wholly of a gas permeable and liquid impermeable membrane. In another embodiment the pump could be a peristaltic tube or hose pump with the hose or tube comprised either partially or wholly of a gas permeable and liquid impermeable membrane.

### 8 Description of Embodiments

The embodiments listed are descriptions of possible combinations of features and are illustrative, not exhaustive. One skilled in the art could develop similar combinations that include or exclude certain items and these combinations are claimed as part of this invention.

### 8.1 Embodiment of Nitrification/Denitrification/and Deammonification (NDD) Treatment

An embodiment of NDD treatment consists of a single tank with scaffolds and complete mixing to evenly distribute influent, dissolved oxygen, and other constituents. In one embodiment the scaffolds have a high surface area that can accommodate growth of a biofilm such as Poret foam, an open reticulated polyurethane foam with surface area in the range of 1,000 m²/m³. In another embodiment the surface area of the structure may vary from 1,00 m²/m³ to 100,000 m²/m³ with a frequently used range of 500 m²/m³ to 5,000 m²/m³. In another embodiment the scaffold is composed of highly porous ceramic material that can sustain high levels of biofilm growth. In another embodiment the scaffold is composed of, or coated with, activated carbon to increase the surface area for growth, enhance biofilm adhesion, and/or reduce the impact of toxics that may be introduced by immobilizing them through absorption.

In one embodiment, mixing of the tank consists of mixing energy capable of maintaining a flow velocity in the range of 0.05 to 5.0 m/s. In one embodiment the mixing is relatively non-turbulent and in the range of 0.05 to 0.5 m/s and is sufficient to substantially evenly mix the liquid contents of the tank but not cause excessive shearing of the biofilm on the structure during normal operation.

In one embodiment, dissolved oxygen (DO) is evenly distributed in the tank liquid and varies from 0.0 to 1.0 mg/l. In an embodiment the DO does not remain constant but varies as necessary to maintain the optimal levels of nitrite for the NDD process. In one embodiment the DO is maintained in the rang of 0.5 to 0.8 mg/l for approximately 10% to 20% of the time with the balance of the time the DO is less than 0.2 mg/l. In one embodiment, a substantial amount of the nitrifiers are suspended in the liquid and consume the bulk of the oxygen before it comes in contact with the denitrifiers and anammox that are part of the biofilm.

In an embodiment the process is controlled by maintaining nitrite in a range of 1 to 50 mg/l as N but preferably below 10 mg/l as N. The target range is maintained by control of the dissolved oxygen level with more dissolved oxygen added as necessary to maintain the desired level. In an embodiment the nitrite target for a wastewater with a high level of ammonia (in the range of 550 to 650 mg/l as N) is set at 3% (with a possible target range of 0.1s% to 50% of the influent ammonia level (mg/l as N), but not to exceed a maximum of 50 mg/l of nitrite as N. Once the target level is reached, oxygen no longer added until the nitrite level drops to 1% of the incoming ammonia level (possible target range of 0% to 30%), at which time oxygen is once again added to achieve the desired target level of nitrite. In another embodiment the influent ammonia is much lower (in the range of 20 to 30 mg/l) and the target nitrite level is set to the 60% level.

In another embodiment of the process control, when the nitrite level rises to levels that inhibit anammox, the oxygen remains off until the inhibition ceases. In an alternate embodiment, the influent feed is stopped or reduced to limit incoming nitrogen and the dissolve oxygen level is raised to above 1.0 mg/l and maintained until the nitrite is transformed to nitrate and the level of nitrite drops at least 10% below the inhibitory level. At this time oxygen addition is stopped until the denitrifiers can remove the bulk of the nitrate that has been generated. Additional organic carbon can be added if necessary to enhance the ability of the nitrifiers to remove the nitrate.

In another embodiment of the process control the pH is maintained in the range of 7 to 9 with a preferred level of 7.7 to 8.2. This also provides sufficient alkalinity for NDD. The overall NDD process consumes alkalinity, therefore, the primary need for pH control is to prevent the pH from dropping below the desired range. However, acid can be added if the pH increases above the desired level since free ammonia at levels beyond a pH of 9 can be inhibitory. In an embodiment the pH level would be maintained using a conditioning element which acts to buffer the process. In an embodiment this can be a mixture of calcium, magnesium, sodium compounds in the form of oxides, carbonates, and hydroxides. The mixture would be targeted to provide buffering over a long period of time such as several days to a year or more in order to reduce maintenance and enhance treatment. The mixture could be calcite and/or dolomite in a granular or crushed rock form that slowly dissolves to maintain the target pH.

In another embodiment of the process control the temperature is varied to maintain the desired ratio of organisms and to enhance treatment. In an embodiment the temperature is maintained at 26 degrees C. to balance the organism mix and enhance treatment. In an embodiment the temperature is maintained by heating of the media so that the medial is maintained at the set temperature while the liquid is closer to ambient temperature. This permits energy savings and also enhances protection of the anoxic/anaerobic organisms that are closest to the media.

In an alternate embodiment the oxygen may be cycled on a predetermined manner that can be adjusted from time to time. For example, the oxygen may be added for 2 minutes every 20 minutes by use of a timer. This could be a useful manner of operation for steady flows and also for small systems that do not have the necessary online monitoring equipment to control the system. An additional variant might have oxygen on/off for a set period of time and periodically change to a long period aeration followed by one of no aeration in order to form nitrates to prevent long inhibitory periods due to nitrite buildup. For example, the system could be set for 2 minutes of oxygen addition every 20 minutes but one a week the oxygen would be added for two hours and then no oxygen would be added for 20 hours, after which the 2/20 cycle would resume.

NDD permits a higher loading rate of ammonia than deammonification alone because the denitrifiers can also remove nitrogen, not just anammox, which can double the ammonia removal rate or more. Additionally, the used of patterned fixed-film treatment (PFT) permits denser growth of biofilm. With media that must be kept in suspension a total occupied volume of 30% is high but this can also be doubled using a PFT system. Batch deammonifications systems generally operate in the range of 0.5 kg/m3/day of ammonia loading and continuous flow systems are in the range of 1 to 1.2 kg/m3/day. An NDD system with a feed that has organic carbon (as BOD) of 80% to 120% of N and using PFT can operate up to the range of 2 to 4 kg/m3/day.

An alternate embodiment of NDD has two or more completely mixed tank in series to approximate a plug flow reactor. In a variant the flow through the tanks may be varied or reversed. For example in a three tanks system the flow may be to Tank 1 to Tank 2 to Tank 3 for a period of time but then reversed to 3, 2, 1. This may be useful to balance biofilm growth.

In an embodiment of NDD, other organisms may be present either attached to the media or in suspension. These include heterotrophic and autotrophic bacteria including those used in activated sludge to remove organic carbon. These organisms would also be controlled by process control to keep them in the correct ratio to other organisms.

### 8.2 Embodiment of Patterned Fixed-Film Treatment (PFT)

An embodiment of a single tank with scaffolds and complete mixing to evenly distribute influent, dissolved oxygen, and other constituents similar to one of the six reactors (R1 to R6) that were described in section 7.1 above. Key features of the reactors that are part of PFT are their use of two identical scaffolds that were placed symmetrically in the center area with gentle but thorough mixing to ensure the scaffolds were exposed to essentially similar environments. The interior of the scaffolds were exposed to a different environment but it was similar to other interior portions of the scaffolds, therefore, this was also part of the pattern.

In an embodiment of PFT, the scaffolds are located in a relatively anchored position to prevent significant movement during operation, are located in a manner (by symmetry or other means) to permit relatively similar exposure, and mixing is provided to facilitate similar exposure to liquids. In a variant the scaffolds are enclosed by a semipermeable enclosure that limits turbulence but permit relatively free liquid interchange. An embodiment of the enclosure would use a membrane with average openings between 0.1 to 10 microns. In an embodiment that can retain most organisms but permit liquid to pass the membrane may have average openings between 0.5 to 2 microns.

In an embodiment of PFT, the media is not anchored but can move freely and mixing and dispersion of constituents of the tank permit a relatively homogenous environment.

In another embodiment the media is not anchored but is free to move and has a semipermeable enclosure that permits liquid transfer but limits the media from turbulence and abrasion. In a variant embodiment these enclosures can be used to rapidly seed a process and can also be used to introduce new organism mixes. In an embodiment the medial and enclosures can have means to adjust buoyancy to minimize the amount of mixing required to keep everything suspended.

In a variant embodiment media may be contained in an enclosure similar to that shown in FIG. 3 that has means to add items such as oxygen, nitrogen, wastewater feed, nutrients, micronutrients, additional organisms, etc. with such means including special piping, tubing, valves, connections, and equipment. The enclosure may also have instrumentation to aid in monitoring and control. The enclosure may also be capable of removing items such as excess biofilm. For example, the structure may be a compressible foam with a 2-micron impermeable enclosure and perforated tubing running through the foam so that a vacuum can be applied and the suction collapses the enclosure, compresses the foam causing it to shed biofilm, which is then suctioned out. The process may be reversed with gas or liquid added to flush into the foam and then suction may be applied once more to remove excess biofilm. This could be used to harvest biofilm for seeding other systems, or used to prevent degradation of treatment.

### 8.3 Embodiment of Invention Directed to Variable Submerged Treatment (VST):

VST varies the submergence of the media to enhance treatment, exploiting the difference between treatment of wastewater when the media is submerged compared to when it is not. For example, a unit may operate with no submergence of the media in a manner similar to a trickling filter and in this mode oxygen is supplied by ventilation air that passes through the media. VST differs from normal operation of a trickling filter by using throttling of the ventilation to induce low oxygen conditions as necessary to proper NDD treatment. Additionally, the liquid level can be allowed to rise and if the liquid is not aerated the portion of the media below the liquid will have a lower DO than the portion that is not submerged and that is being ventilated. This is a form of Patterned Fixed-film Treatment (PFT) and can be used to optimize treatment. Treatment is enhanced by better control of oxygen and temperature.

One embodiment of VST is a tank filled with rigid structured media similar to that used for a tricking filter with surface areas 500 m²/m³ to 5,000 m²/m³. The system has NDD treatment and flow is recycled, generally in the range of 100% to 200% of flow. The system is ventilated with fans and vents which introduce air from the top and draw it down into the media (concurrent ventilation) maintaining the rate of ventilation to maintain a nitrite range in the collection sump under the media of approximately 2% of the influent ammonia level (as N). At that time ventilation would be stopped until the nitrite level dropped to 0.1% of the influent ammonia level; once this was reached ventilation would be restored. A variant would be to keep then ventilation level steady but to let the media be submerged in non-aerated liquid as the nitrite level starts to reach the target level at which time all the media would be submerged and there would be no ventilation. Once nitrite levels dropped the submerged level would be dropped again.

In an embodiment the media is heated to maintain its temperature at 24 degrees C. to enhance treatment and a pH/alkalinity buffer such as granular calcite are maintained in the sump to minimize pH fluctuations.

### 8.4 Embodiment of Septic Tank and Other Treatment Systems

An embodiment for an add-on unit for a septic tank consists of a conditioning element capable of conditioning influent flow to provide optimal treatment conditions. This conditioning would include flow control and dispersion, mixing to attenuate spikes, micronutrients for optimal growth, and pH and temperature adjustments to optimize conditions for growth. The treatment element would optimize conditions to provide both concurrent nitrification/denitrification (SND) and for deammonification. This element is designed to provide optimal interface of organisms to food and to also maintain their respective requirements for microenvironmental conditions for different organisms including the presence or absence of oxygen, ammonia, nitrite, nitrate, etc. Accordingly, in an embodiment the add-on unit for septic tanks has the following:
A 55-gallon total sized unit. Sized for a typical family of 4 with an average flow of 300 GPD. For this size unit the total volume of the add-on unit would be approximately 55 gallons as detailed below but volume could vary as needed for different flows and concentrations).
A connection element that would permit intercepting the line from the septic tank to the drain field, diverting flow to the add-on treatment unit, and directing flow back once the flow was treated. The unit would also have a bypass to return flow to original conditions if necessary or desired. In the embodiment this would consist of a PVC line the same size as being intercepted, generally 4-in diameter, and would have a PVC ball valve in the influent and the effluent line to the add-on unit. The bypass would connect the line between the two breaks for the tie-in and would also have a ball valve to permit it to be closed when using the add-on unit and to be open when bypassing is desired.
A filtering element that could retain large particulate matter to prevent buildup of material and clogging
A metering element that could also be used to control the process.
A 30-gallon conditioning element consisting of one or more of the following: a header to distribute influent, a bed or coarse calcite to buffer the pH and maintain it between 7.0 and 8.0, an added mixture of slow release micronutrients encapsulated to release over a period of a year, two heaters each capable of maintaining a set temperature within 0.5 degrees C., a collection header to transfer flow to the treatment element, and a sump that can collect debris and sludge from the unit. Volume could vary as needed and be sized for different flows, concentrations, and temperature ranges than those listed herein.
A 15-gallon treatment element consisting of fixed film media for a mixed biofilm of at least nitrifiers, denitrifiers, and anammox organisms, an aeration source that both provides distribution of the influent flow and adds oxygen in quantities optimal to maintain the proper mix of organisms and remove organics and nutrients, a heater to vary and optimize temperature, and a collection header to transfer flow to the clarification unit. The media will be 1.5 cubic feet of PVC media similar to what is used in a trickling filters, will be cross flow with openings sized not to clog, and will have a surface area of 150 m²/m³. The oxygen will be added by a small air pump similar to those used in ponds and larger aquariums. The unit is a linear diaphragm unit that can be varied to deliver up to 10 lpm. In the current embodiment the air flow would be varied based on maintaining a target Redox level at the exit of the treatment unit of 250 mv. In another embodiment the aerator would run from a timer as outlined in section 8.1 above for NDD treatment. A redundant air pump would also be supplied in the embodiment. In another embodiment, oxygen may be supplied by other passive and active methods including those outlined in section 8.10 below in the discussion of a floating treatment system (FTS). Volume of the treatment element could vary as needed and be sized for different flows, concentrations, and temperature ranges than those listed herein.
A 10-gallon clarification element with integrated sump. The clarification unit would have lamella plates midway in the unit to help distribute influent and effluent flow and to capture additional solids. The integral sump would have a small pump that would run on a timer to transfer any solids back to the septic tank. The pump would have a small line with a check valve that would be routed to the septic tank for this purpose. In an alternate embodiment the sump may be large enough to store solids for up to one year to facilitate annual removal during other inspection and maintenance. Volume could vary as needed and be sized for different flows, concentrations, and temperature ranges than those listed herein.
An instrumentation and control element to monitor and/or control the treatment process. The embodiment includes a system to monitor and control the process of the add-on unit. Monitoring includes an interface with a SCADA system to relay information to the homeowner and/or a service company. SCADA could report the status of the system, if it has power, if all equipment is working properly, high level indication, and process parameters of interest such a flow, pH, dissolve oxygen level, ammonia, nitrite, nitrate, and redox in one or more points in the system. The control system also has the ability to start and stop equipment at set times, based on a timer, and/or based on a signal from the system. An example of the latter control would be the starting and stopping (or adjustment of speed) of an aerator to maintain a set dissolved oxygen or redox level. In the embodiment all equipment is monitored for correct operation and/or failure, and air addition is based on a desired redox level with more air being added to raise the redox level or less added to lower it. The target redox level would be 250 mb. Additionally, the control system can be remotely adjusted to change manner of operation. For example, if the redox probe failed or was not properly calibrated then the mode of operation could remotely be changed to add air based on a timer or the speed of the aerator (and the amount of air it pumped) could be manually adjusted. Additionally, in a alternative of the control scheme, the temperature can be varied if necessary to shift the balance of organisms to optimize treatment. The temperature could be varied by a number of means including heating of liquid, heating of injected air, and/or heat transfer from solids surfaces including heating of the media.
A highly standardized mixture of organisms element to ensure repeatable, controllable results. In the alternative the mixture would be composed of three separate live cultures comprised of nitrifiers, denitrifiers, and anammox bacterial. In one embodiment the specific combination could include high performance nitrifiers patented by Vanotti (U.S. Pat. No. 8,445,253) anammox patented by Vanotti (U.S. Pat. No. 8,574,885), and any commercially available denitrifiers. The preferred ration of the organisms being approximately 50% anammox and 25% each nitrifiers and denitrifiers.

### 8.5 Embodiment a Completely Integrated Treatment System

The completely integrated treatment system is designed to recycle a large amount of the waste it receives. An embodiment the system uses a screen capable of removing all items larger than 1-in by ½-in. Screened influent is ground to a ¼-in or less to prevent downstream clogging. The flow proceeds to a settling/flotation unit that is anaerobic and is covered. In addition to settling the unis uses recycled anoxic gas from the unit headspace to float additional solids to improve removal facilities. Solids collected from settling and floatation are sent to a digester for further processing. Once most solids have been removed the flow is sent to a nutrient recovery tank where the pH is adjusted to approximately 8.5 to 9 and magnesium hydroxide is used to precipitate phosphorus and nitrogen in the form of struvite. This is removed and used as a fertilizer. Effluent from nutrient recovery proceeds to a polishing unit which removes soluble organic carbon and unprecipitated nitrogen using two cell NDD form of treatment which serves as a polishing unit. Effluent can be discharged into a waterway but in an embodiment the effluent is further polished in a small wetland. Treated wastewater can them be removed by membranes or other means of solids separation. Solids removed from this process are also sent to the digester. The digester has a mixer and grinder to recirculate flow to enhance degradation. Supernatant is sent back to the head end of the plant to be retreated. Gas, which is primarily a mixture of methane and CO2 are withdrawn and a substantial amount of CO2 is removed by passing it through algal treatment and the final methane rich gas is used to generate electricity with a fuel cell. Algal byproduct is used as fertilizer or as an animal food source. Key features include the grinding of solids finely, anaerobic settling/flotation, P and N recovery, polishing, and integrated use of a digester to beneficially recover a substantial amount of waste removed.

### 8.6 Embodiment of Retrofit of a System

An embodiment of a retrofit an existing treatment plant would be installation in an aeration tank of a system that was removing only organic carbon. Installing an NDD system into the existing aeration basin and using the existing air system to supply the necessary oxygen for the process would minimize cost and provide quick payback. Air requirements would remain similar to that needed for removal of organic carbon. The system would need to produce nitrite for deammonification and denitrification but there would be less need for mixing and the overall dissolved oxygen level could be maintained much lower than the common level of 1 to 2 mg/l for activated sludge.

### 8.7 Embodiment of Compact Treatment

A compact treatment system can be used in situations where space is at a premium or locations that may have problems with fluid flow and mixing such as reduced gravity conditions. One embodiment that could be used on the international space station to treat wastewater primarily composed of urine with no fecal material. The wastewater would be high in nitrogen, having approximately 650 mg/l of ammonia as N and about 700 mg/l of chemical oxygen demand. Approximate flow would be about 20 liters per day. The treatment system would be a rectangular cubic structure with dimensions 450 cm×450 cm×450 cm. Membranes would have dimensions of 30 cm×30 cm× by approximately 2 cm thick. Biofilm scaffolds of expanded ceramic foam with similar dimensions would be alternately placed between the membranes and the distance between membranes and scaffolds would be 20-cm. These would be place parallel to each other along the long axis of the system with approximately 50 membranes and 50 scaffolds used. Membranes would be flat ceramic membranes with average openings of 2.0 micron with normal filtration from the outside in when extracting effluent and inside out when oxygen is fed on the alternate membranes. The system would be operated to maintain the pH between 8.0 and 8.5 and the temperature maintained at approximately 28 C. Operation would be controlled by nitrite content of the wastewater with a target nitrite level of 2% of the influent ammonia level which when reached would stop oxygen flow until the nitrite level reach 0.2 mg/l; at which time the cycle would start again. Membranes for effluent and oxygen would switchover once per day and cleaning would cycle as needed.

### 8.8 Embodiment of a Method and Means to Preserve, Store, and Reactivate Organisms and Other Substances

OVERALL: One embodiment of the present invention consists of one or more items selected from a group consisting of enclosures (1514, 1702, 2218), structures (1510, 1512, 1602, 1604, 1702, 1802, 2210), processes (1506, 1902, 1904, 1906), devices (1502, 2002), appurtenances (2102, 2212, 2220) and mixtures of microbial organisms that can be used in the preservation, storage, and reactivation of organisms and/or other substances such as pharmaceuticals.

Enclosure (1514, 1702, 2218)One embodiment of the present invention is an enclosure that can be used for a purpose to be selected from one or more items in the group comprising preservation, storage, and reactivation of organisms and/or pharmaceuticals.

Structure (1510, 1512, 1602, 1604, 1702, 1802, 2210) One embodiment of the present invention is the use of a structure that can be used for a purpose to be selected from one or more items in the group comprising preservation, storage, and reactivation of organisms and/or pharmaceuticals. Said structure can be used to support organisms and/or pharmaceuticals in a manner that better permits their preservation, storage, and reactivation. Said structure can consist of items selected from group comprising solid and porous materials including foam (metal, ceramic, carbon, plastic, open cell, closed cell, thermally conductive, thermally insulating, electrically conductive, etc.), and/or assemblages of one or more shapes comprising (spheres, cubes, dodecahedral, fullerenes, other geometric shapes, and amorphous shapes)

Process One embodiment of the present invention is a process and/or substance that can be used for a purpose to be selected from one or more items in the group comprising preservation, storage, and reactivation of organisms and/or pharmaceuticals. One such process is preservation techniques which includes freeze drying (lyophilization), vacuum drying, spray drying, encapsulation, and other similar technologies.

Devices One embodiment of the present invention is a device that can be used for a purpose to be selected for the preservation, storage, and/or reactivation of organisms and/or substances.

Appurtenances One embodiment of the present invention is are appurtenances that can be used for a purpose to be selected for the preservation, storage, and/or reactivation of organisms and/or substances.

Mixtures of Microbial Organisms One embodiment of the present invention consists of one or more items selected from a group consisting of enclosures, structures, and process that can be used for a purpose to be selected from preservation, storage, and reactivation of microorganisms.

This invention consists of one or more items selected from a group consisting of enclosures, structures, appurtenances, and processes that can be used in the preservation, storage, and reactivation of organisms and/or other substances such as pharmaceuticals. Each item in the group are discussed in more detail below.

An Embodiment for Preservation Consists of the Following:
1. An enclosure (1514, 1702, 2218) that protects the other embodiments of this invention including structures, processes, devices, appurtenances, and mixtures of microbial organisms. In the embodiment the enclosure is comprised of 2-micron opening cellulose filter material that fully encloses the unit being preserved but which permits discharge and introduction of liquids and/or gas.

A variant of the enclosure would be one similar to those used for filtration of milk.

A variant of the enclosure could have some sections that are permeable and others that are not. Additionally, some areas could be selectively permeable to certain fluids such as gas but not permeable to liquid fluids.
Other structure variants are listed below in the section on other embodiments.
2. A structure (1510, 1512, 1602, 1604, 1702, 1802, 2210) consisting of scaffold of open cell reticulated polyether polyurethane foam to support a mixed culture of microorganisms comprising of a biofilm.

A variant of this step may include use of a scaffold material including vitreous carbon foam, ceramic foam, metallic foam, or other suitable structure.

A variant of this step may include other types of fixed structures including lamellas, honeycombs, etc.

A variant of this step may include structures that are not immobile such as plastic filter media with high surface areas such as kaldnes or granular media such as sand and/or activated carbon.

Other structure variants are listed below in the section on other embodiments
3. A process to remove of excess free fluid from scaffold and organisms and/or substances by draining or other means. In an embodiment this would be done by draining the scaffold and waiting at least 5 minutes for draining is relatively complete.
   A variant of this step may include the filtering of the fluid that is drained to recover additional organisms and/or substances

A variant of this step may include a partial vacuum to draw off excess liquid

A variant of this step may include high pressure air to draw off excess liquid

A variant of this stem may include inducing vibration of the scaffold to draw off excess liquid.
4. A process to concentrate organisms and/or substances by filtering, centrifugation, and/or other means. In an embodiment the liquid suspension drained from the reactor is centrifuged and the concentrated solids are transferred onto the scaffolds for preservation.

A variant of this step would be filtering through a 0.45 um filter to permit retention of any organisms in suspension instead of centrifuging. These filters may afterwards be affixed on the scaffolds to be preserved with them.

A variant of this step may include the centrifuging of li
5. A process to add cryoprotectant. In an embodiment this would be 2 parts skim milk for each part of the organisms and scaffolds. Other variants may be as follows:

Addition of 0.2M trehalose as a cryoprotectant

10% sucrose may be used instead of 0.2M trehalose

Other cryoprotectants may include skim milk, polysaccharides, dimethyl sulfoxide (DMSO), glycerol, polyols, glycols and mixtures containing several cyroprotectancts

Means of removing excess cryoprotectant may be the same as used to remove excess liquid from scaffold and organisms.
6. A process to decrease the temperature to −50 degrees C. by refrigeration at a rate of 1 degree C. per minute is an embodiment. Other variants include decreasing temperature to below freezing, including to the temperature of liquid nitrogen (−195.79 C), to dry ice (−78.5 C), or other temperature selected. Or vacuum drying at 5 degrees C. above freezing. Or decreased temperature by addition of liquid nitrogen, dry ice, etc. Or changing the rate of temperature change including very short time periods such as flash freezing and/or submergence in liquid nitrogen.
7. A process to remove remaining moisture by use of a full or partial vacuum to preserve the organisms and/or substances. In an embodiment the vacuum is to be applied at 10⁻³ mbar for the time necessary to bring final moisture content to 5%.

A specific variant of this step is to use a natural full or partial vacuum that is available in space or on bodies with atmospheres less dense that on earth.

Final moisture content may be varied depending on organisms and/or substances

Vacuum to be applied may be varied depending on organisms and/or substances.
8. A process for final preservation in a vacuum of <1 ; Pa and 4 degrees C.

Variant is storage at room temperature with a vacuum of <1 Pa

Variant is storage in a container of dry nitrogen gas that is 5% over the ambient pressure. Pressure to be maintained as necessary.

Variant is vacuum or nitrogen storage in situ
9. A device capable of cryogenic freezing such as a MVE HECO 1800 Series freezers as manufactured by Chart Industries (or similar) which provided the temperature necessary for lyophilization.
10. An appurtenance capable of even dispersion of the cryoprotectant on the scaffold and organisms such as a Merkur airless sprayer (assembly part no. G23C04).
11. A mixture of microbial organisms for the desired purpose. In an embodiment this is a combination of nitrifiers, denitrifiers, and anammox organisms grown on the scaffolds. In another embodiment these organisms are those used in Pancopia's Phase I SBIR contract with NASA.
12. Additional variants of the above steps include:

The preservation of the structure (3012,3014) and microorganisms and/or substances in situ without removal. Additional variants are storage in situ and reactivation in situ.

Other process variants are listed below in the section on other embodiments

Other device variants are listed below in the section on other embodiments

Other appurtenance variants are listed below in the section on other embodiments

Other organism mixture variants are listed below in the section on other embodiments.

Inclusion of bacteriophages such as Inoviruses and/or other filamentous bacteria to increase adhesion and/or desiccation properties of biofilm prior to preservation.
Varying ionic strength to increase adhesion of bacteriophages
Adding of polymers such as alginate to improve adhesion of biofilm (even if there are no bacteriophages)
Development of liquid crystalline formation to enhance biofilm adhesion.

Induced dormancy
Use of wastewater for dormancy solution. Add molybdate and seal system so that when oxygen is all consumed by nitrifiers and they shut down then the denitrifiers and anammox can consume all their nutrients and shut down too.

An Embodiment for Storage Consists of One or More of the Following:
1. An enclosure capable of protecting all items and maintaining the desired conditions
2. A structure to provide for storage of the organisms
3. A process to monitor and maintain storage

A process for the addition of items to enhance long-term storage. In an embodiment this would be maintenance of a vacuum during storage

Variants of items would be the addition of substances such a molybdate to prevent or retard the growth of undesirable organisms such an anaerobic sulfur reducers.

A process for removal of units for long term storage

A process for storage in situ without removal of the enclosures, structures, devices, appurtenances, and/or mixed microbial organisms.
4. Appurtenances for monitoring of storage
5. A mixture of microbial organisms that have been put into storage
6. Additional variants of the above steps include:

The preservation of the structure and microorganisms and/or substances in situ without removal. Additional variants are storage in situ and reactivation in situ.

Other process variants are listed below in the section on other embodiments

Other device variants are listed below in the section on other embodiments

Other appurtenance variants are listed below in the section on other embodiments

Other organism mixture variants are listed below in the section on other embodiments.

An Embodiment for Reactivating Consists of One or More of the Following:
1. An enclosure design to aid in the reactivating
2. A structure to protect during reactivation
3. A process to monitor and maintain reactivation
4. Appurtenances to aid in reactivation
5. A mixture of microbial organisms to be reactivated Note: In an embodiment the enclosure may be permeable to liquids but which will retain microorganisms. The porosity of the enclosure can permit the entrance of liquid to dissolve and removal the cryoprotectant while containing the organisms.

Other Embodiments of the Invention are as Follows:

Other embodiments of preservation may include one or more of the following: induced dormancy, vacuum drying, spray drying, encapsulation, and other similar technologies. Specifically called out is the use of natural vacuum (and partial vacuums) to aid in preservation and for vacuum drying which does not require temperatures below 0 C. Other variants include addition of micronutrients to aid preservation by making the organisms hardier, induced dormancy by reduced nutrient loading, and addition of phages and/or other means to aid the biofilms adherence.

Other embodiments of storage may include one or more of the following: storage at room temperature, refrigerated storage, moisture controlled storage, storage with inert gas, encapsulation, addition of micronutrients, regular changeout of fluids used for storage.

Other embodiments of reactivation may include one or more of the following: use of nutrient broths to aid reactivation, reactivation using wastewater stream to wash out cryoprotectant, and addition of small amounts of live organisms to aid in reactivation.

Other embodiments of enclosures of this invention may have one or more of the following characteristics:
‘Filters’ to enclose organisms and/or substances that are to be preserved (similar to a coffee disc) permitting the addition of media to reactivate the organisms
   Wherein the filter does not permit all of the organisms and/or substances to escape during preservation, storage, and/or reactivation
   Wherein the filter does permit other constituents of the items to be preserved (such as the cryoprotectant used) to be removed and retaining at least some organisms in the filter
   Where the filter has growth aids
   Where the filter dissolves after a period of time
   Where the filter is designed to be opened easily (prescored or selective perforations that do not totally penetrate but make opening easier.
   Use of an closure for the filter that can be easily opened such as an adhesive that dissolves after a period of time
   Where the filters can be prepared locally instead of lyophilization facility and then the entire filter lyophilized
   Where the filters can be assembled after the organisms are lyophilized
Design of encapsulation could permit optimal freeze drying without short circuiting
   Encapsulation could be designed to permit freeze-drying of individual (or small lots) of filters.
   Optimal encapsulation design could also permit reactivation with no short-circuiting and/or dead spots.
Encapsulation of organisms for future reactivation.
   Easier to encapsulate with use of a filter. Filter can capture organisms, cyroprotectant and other items can be added by diffusion across the membranes, excess drained from the filter, lyophilizing can be performed, and the resulting filter with lyophilized organisms can be stored in a structure (3012, 3014) that protects the filter and its contents from temp, humidity, vibration, light, gases, etc.
Filters that are designed to be used for both induced dormancy and lyophilization as desired
Filters with corrugated scaffolds to host organisms and designed to specifically mediate induced dormancy and/or lyophilization
Filter packets that can be quickly prepared for lyophilization or induced dormancy. Perhaps a quick flush of excess organisms (or not) and then injection of the fluids necessary for induced dormancy or lyophilization
Use of cellulose for filter that can later be degraded. Also use of superabsorbent gels between cellulose filter and outer casing in order to maintain dryness.
Have a non-dissolvable inner filter with larger micron openings and a dissolvable (or easily removable) outer filter (to permit reactivation). The dissolvable (or removable) filter would be reapplied when lyophilizing organisms or inducing dormancy.
Containment of organisms may be done in a structure that has a combination of one or more characteristics selected from the group containing: permeable membranes, semipermeable membranes, non-permeable structures, degradable membranes, non-degradable membrane, degradable non-permeable structures, non-degradable non-permeable structures, partially degradable structures.
Filters may be similar to those used for milk filtration

Other Embodiments of Structures of this Invention may Have One or More of the Following Characteristics:
Including structures in the ‘filter’ for the organisms to attach to or that they have already attached to (prior to lyophilization)
   Inclusion of a structural material that can take the stresses of lyophilization
Various meshes
   Expanded metal or metal foam for strength and thermal conductance (and possibly magnetic properties)
   Ceramic from for strength and being non-conductive
Organisms can be contained on structures that can be used to preserve a favored ecological niche.
Organisms can be contained on structures that have characteristics that permit easy separation (such as embedded magnetic substances or substances that are attracted by magnets)
Embedded items could be used to selectively culture organisms. For example, metal structures (perhaps coated with plastic) could be use and microwaves or other methods could be used to heat the metal and create a more favorable environment.
Use of support structures such as scaffolds and other media
Filter enclosures designed to aid lyophilization and/or reactivation including materials that can selectively admit or exhausts fluids such as gortex™.
Structure that is thermally conductive to aid in controlling temperature surrounding organisms and/or substances
Structures can increase the surface area of exposure and reduce the amount of organisms and/or substances that are hindered from even preservation by other organisms and/or substances.

Other Embodiments of Processes of This Invention may Have One or More of the Following Characteristics:

Method to reactivate—Automation of the method to reactivate; Monitoring of important parameters (such as temp, DO, pH). Inducing dormancy—How to induce, store, monitor, and/or reactivate. Reactivating after dormancy. Lyophilizing in space and taking advantage of vacuum for freezing (and possibly thermal heating also). Buffers to prevent sharp pH drop when reactivating. Other preserving such as spray drying. Encapsulation. Segregation of bacterial classes to permit optimal separate reactivation if desired. This can also be used to mix and match different combinations
Can be used to treat specific pollutants (such as Dimethyl Sulfide)
Means to evacuate excess quick growing organisms such as nitrifiers and denitrifiers (maybe a connection to flush and one to flush too with built in check valves) food and then go dormant. Molybdate can still be used to inhibit sulfide formation.
Vacuum drying could be used in places where partial or full vacuums are readily available such as space, space structures, and/or low atmosphere bodies such as asteroids. To prevent escape of excessive moisture and/or to aid in preservation the organisms and/or substances can be drained and/or partially dehydrated in an atmospheric space with exposure to vacuum only after a large amount of the original moisture is removed.
Method to determine best scaffold material includes testing cubes of material by wetting each cube and then lyophilizing it. Once lyophilized the cube can be defrosted and submerged in water for an hour and then its mechanical properties can be tested to see if it retains its integrity.

Other Embodiments of Devices of this Invention may Have One or More of the Following Characteristics:
Reactor specially designed for enclosures
Reactor designed to preserve, store, and reactivate organisms and/or pharmaceuticals in situ
Could make use of thermoelectric coolers to aid dropping the temperature
A device designed to use natural full or partial vacuum to assist in the preservation of organisms and/or substances

Other Embodiments of Appurtenances this Invention may Have One or More of the Following Characteristics:
Racks that can hold structures (3012, 3014) and scaffolds for easy removal Other embodiments of mixtures of microbial organisms this invention may have one or more of the following characteristics:
Organisms can be used that can degrade unwanted substances such as dimethyl sulfide.

### 8.9 Embodiment of a Complete, Prefabricated Wastewater Treatment System

An embodiment of a complete prefabricated wastewater treatment system would be similar to the integrated treatment system above but would come as a complete system with dimension similar to a cargo box used for shipping, for example, 12-ft by 12-ft by 40-ft. Organisms for the NDD unit would be provided in a dormant state already adhering to the biofilm structure.

### 8.10 Embodiment of a Floating Treatment Structure (FTS)

An embodiment of a floating treatment structure floating structure of 12-feet diameter with a ½-in black plastic cover and a 12-in diameter solar chimney. The biofilm scaffold would be be 6-inches thick with 4-inches submerged and 2-inches above the waterline. Additionally, there would be a 2-in clear space between the cover and the top of the foam. Thus, the cover would be 4-inches above the waterline. The scaffold would be constructed of open cell reticulated polyurethane foam and would be in eight pie-shaped sections (each section sweeping an arc of 45 degrees). Each section would be encapsulated in an enclosure with approximately ¼-in mesh and would have flotation around its perimeter to keep the scaffold the and overall FTS at the correct elevation. The FTS would have a 12-in draft tube with motorized propeller which be powered by solar cells mounted on the FTS. The FTS unit would be used to treat lagoon wastewater generated by humans or animals.

In another embodiment the circulation of water is naturally induced. In another embodiment the air is force ventilated. In another embodiment the FTS is supplied power from the shore. In another embodiment the FTS is of a rectangular shape. In another embodiment FTS units are configured to substantially cover the water surface. In another embodiment the FTS is equipped with chemical lines that can be used to disperse chemicals in the water. In another embodiment the organisms are those used for NDD treatment. In another embodiment the organisms used can oxidize iron and/or manganese. In another embodiment the organisms are specialized as removing low levels of organic carbon; including tannic and humic acids.

### 8.11 Embodiment of a Degassing Pump

One embodiment of the pump is a diaphragm pump with a diaphragm composed of reinforce GORTEX, a porous form of polytetrafluoroethylene with a micro-structure characterized by nodes interconnected by fibrils. As the diaphragm operates to pump fluid, gas that is out of solution or that comes out of solution due to pressure variations in the diaphragm pump are expelled though the diaphragm while the liquid is pumped. In an alternate embodiment that membrane is composed of poly-di-methyl-siloxane (PDMS) supported by a perforated PVC plate. In an alternate embodiment the PDMS is coated with a thin layer of Teflon AF to improve performance, chemical resistance, and durability. In an alternate embodiment the diaphragm is composed of reinforced Superfabric™. In another embodiment the diaphragm is composed of the normal material of the pump manufacturer with a section of the diaphragm composed of gas permeable membrane.

In another embodiment of a degassing pump the pump is a peristaltic tube pump with the tube material having the same range of options as those for the diaphragm pump.

### 9 DESCRIPTION OF FURTHER EMBODIMENTS

9.1 Further Embodiments of Septic Tank and Other Treatment Systems

Additional embodiments for an add-on unit for a septic tank consists of the following:
Size of Unit: Additional embodiments of the add-on unit can use larger or smaller size units and the number of elements and their size may be varied. For example:
   A smaller unit could be used for a family of 4 if the wastewater had extremely homogenous composition by reducing the size of the conditioning unit to 15 gallons instead of 30 gallons.
   A larger unit could be used for multiple households tied into on larger tank. For example, a 500-gallon system might be used for a septic tank treating waste from 10 families of 4. The size of the system may be reduced somewhat (in this case by approximately 10%) due to the lower peaking factor that can be used with multiple residences on one system.
   A larger unit may be used for a family of 4 if additional treatment is desired. For example, if less suspended solids were targeted, the size of the clarifier could be increased to obtain superior performance. Similarly, if greater nitrogen removal was desired the treatment unit could be upsized.
Connection Element: Additional embodiments of the add-on unit can use different tie-in elements. For example:
   One alternative would be to locate the add-on unit inside the septic tank. The unit could be installed through the existing access to the tank or through a new opening.
   Another alternative would be to modify the septic tank so that the add-on unit was part of the tank. For example, the add-on unit could be located directly above the septic tank with part the unit extending into the tank and part outside of the tank.
   The tie-in element could contain flexible couplings to permit ease of connection and also make provision for differential settlement.
   The tie-in element could have an integral flow meter to monitor flow to and/or from the add-on unit.
   The valves for the unit could be motorized and remotely controlled
   Other types of valves, such as butterfly valves, could be used instead of ball valve.
   V-notch ball valves could be used to regulate flow and could be remotely actuated to open and close periodically to clear debris and ensure proper operation.
Screening Element: Additional embodiments of the add-on unit can use different conditioning elements. For example:
   One alternative would be to use a screening element similar to those used to screen effluent from a septic tank to prevent clogging of the distribution piping.
   The screening element could be removable from the treatment unit to permit it to be serviced, inspected, cleaned, and/or replaced. The removal point could be a general access point or it could be a point used solely for the filter element.
   The screening element may have a removable and/or replaceable portion to clean and/or dispose of. In one embodiment, the screening element may be comprised of a screening mesh that can be removed and disposed of as trash. The disposable screening mesh may have a companion disposal bag to permit efficient, sanitary disposal.
   The screening element may be equipped with a high level element to detect if it is becoming clogged and in need of maintenance. The high level element may be a capacitive sensor, a flow switch, or other similar item.
Flow Element: Additional embodiments of the add-on unit can use different conditioning elements. For example:
   A magmeter may be used to monitor flows
   A simplified magmeter may be used that only approximates the flow rate. This may be sufficient to control the process due to the low flows and the low flow range and head (pressure) to drive flow through the unit.
Conditioning Element: Additional embodiments of the add-on unit can use different conditioning elements. For example:
   Influent could be distributed by means of a header or weir to ensure even application, mixing, and flow through the unit.
   The conditioning element may use other materials to adjust pH such as ground coral, magnesium oxide, limestone, sodium hydroxide, potassium hydroxide, calcium hydroxide, sodium carbonate, potassium carbonate, sodium bicarbonate, addition of carbon dioxide to reduce pH, and/or air stripping of carbon dioxide to raise pH. One desirable range would be maintaining pH from 7.5 to 8.5 to enhance the growth of nitrifiers, denitrifiers and anammox.
   In addition to pH control the conditioning element may be capable of supplying alkalinity as needed for biochemical reactions such as nitrification.
   Temperature could be maintained by one heater instead of two or could use a multiplicity of heaters. The temperature could be maintained by locating the conditioning element deep enough to be stably heated geothermally. The manner of head additional could be varied so that an insertion heater was used or a heated jacket was used to maintain temperature.
   Temperature can also be maintained by using material in the unit to conduct heat and provide the desired temperature for treatment. The material may be integral in the conditioning unit or may be another type of added material. An example of this would be using calcite to adjust pH and also using it by applying heat to the calcite at one location and having it transmitted through the unit.
   In an additional embodiment, the conditioning tanks could be cooled by use of material added to the conditioning tank
   Air could be added to promote mixing and/or to strip out undesirable elements such as ammonia.
   The conditioning unit could have an opening to add items such a micronutrients.
   In an additional embodiment a substance could be added that would either retard or enhance the growth of one or more particular organism (such as allylthiourea or azide) in order to adjust the ratio of organisms to the desired level.
   The conditioning unit could have a reservoir containing items such as micronutrients and these could be added according to a fixed schedule or as needed.
   The conditioning unit could contain micronutrients encased in a matrix that permits their dissolution over a long period of time selected from several days to more than a year.
   The following micronutrients could be added as needed: Calcium, magnesium, sulfur, iron, zinc, manganese, copper, molybdum, cobalt, etc.
   The size of the conditioning unit could be varied to optimize operation and/or accommodate maintenance cycles. For example, a larger conditioning unit could be used at a site known to have inhibitory substances so that any spikes would be attenuated. Another example would be to upsize the conditioning unit so that the calcite that was used in pH adjustment did not have to be supplement with new calcite as often.
   In another embodiment the conditioning unit is set deeper in the ground that the treatment unit to permit additional thermal warming from the soils. For example a cylindrical unit might have the conditioning element in the lower part and the treatment element directly above it.
Treatment Element: Additional embodiments of the add-on unit can use different treatment elements. For example:
   Influent could be distributed by means of a header or weir to ensure even application, mixing, and flow through the unit.
   The influent could be modified to add the bulk of the flow to one area while directing less flow to another area
   Air could be added in a manner to induce flow through the unit in a manner similar to an airlift pump.
   Air could be added at the bottom of an upward segment of the treatment element thus inducing flow upward and this flow could flow over a baffle and continue in a downward flow manner into a clarification unit.
   Air could be inducted using a venturi effect, such as mazzei injectors use, to be the major source of added oxygen or as a supplemental source.
   Air could be added to both aerate and also to clean the media periodically. Extra air could be added to increase turbulence and clean the media. This could be done on a timer that could be set for low flow periods such as the middle of the night that would enhance removal by the clarifying element.
   Air could be added differentially in the treatment unit to promote optimal treatment. The differential could be spatial or temporal with the latter implemented by varying the overall flow of air, including at times to not add air if this is desirable.
   Different types of media may be used including loose media (such a used to pack air stripping towers), sand, PAC, etc. Fixed media may be varied in shape particularly depending on its location with more open media located at the influent where greater biological growth occurs.
   In another embodiment the treatment unit could have media that was not submerged and would be similar to a trickling filter
   In another embodiment the media might be partially submerged and would be similar to an RBC or to a partially submerged trickling filter.
   In another embodiment the treatment unit could alternately be full of liquid, partially submerged, and/or empty of free liquid. This may be done to control the growth of all of the organisms and/or to promote or retard the growth of particular organisms to adjust the optimal ratio of the organisms. This could also be done to enhance treatment in some manner such as stressing of organisms to promote addition uptake of phosphorus.
   A special mixture of high performance organisms could be added to enhance treatment. For example, a patented mixture of high performance nitrifiers could be added to enhance treatment at lower temperatures. The organisms could be added at the commencement of treatment or periodically as desired (for example adding nitrifiers as temperature drops to ensure treatment). The organisms may be added in a lyophilized state or they could be added live. The addition could be by adding the organisms alone or the organisms could be added on a media that prevents washout. Use of a special mixture of high performance organisms can also be used to reduce the size of the treatment unit.
   Temperature could be maintained by one heater instead of two or could use a multiplicity of heaters. The temperature could be maintained by locating the conditioning element deep enough to be stably heated geothermally. The manner of head additional could be varied so that an insertion heater was used or a heated jacket was used to maintain temperature.
   Temperature can also be maintained by using the media to conduct heat and provide the desired temperature for treatment. For example, the media may have a central spine that is in contact with the media and transmits heat directly to the media in order to warm the media itself and the attached biofilm without the need to heat all the water. In another embodiment the media itself has sufficient thermal conductivity to transmit heat to maintain the desired temperature
   The media could be thermally connected to an element that extends downwards into a warmer stratum, thus providing a zero or low energy way to keep the temperature stable. The element could have a small mixing element to keep the thermally conductive fluid circulating. Or it could be a solid section that naturally conducts the heat to the media. Passive geothermal heating has the ability to maintain a 10 degree F. from the ground surface. In the winter it has the capability of maintaining the unit at a minimum of 47 degrees F. in the northern parts of the United states to 72 degrees in the southern areas.
   The temperature could be maintained in the unit by use of geothermal tubing wrapped around the unit and extending downward. This may be sufficient in itself or it may be supplemented direct heating of the media as described above.
   In an additional embodiment heat can be applied differentially to the media, or could be tapered as it extends along the media, in order to promote a different mix or ratio of organisms as desired.
   In an additional embodiment, the organisms could be cooled by the methods described above using thermal conductivity to lower the temperature of the media.
   Heating of the media directly has the advantage of promoting the growth of the most sensitive and critical organisms, namely, anammox (and to a lesser extent denitrifiers). This can be used to provide a competitive advantage to these organisms if other types begin to grow too fast compared to the anammox.
Clarification Element: Additional embodiments of the add-on unit can use different clarification elements. For example:
   In an additional embodiment the clarification unit could have lamella plates or other aids to settlement. Additionally, the lamella plates could be vibrated at times to remove buildup of solids.
   In additional embodiment the clarification would be a separate unit spatially from the treatment unit.
   An external pump instead of one in an integral sump could perform removal of biosolids from the clarification unit.
   The clarification element may incorporate a storage sump large enough to permit occasional emptying such as semiannually when the unit is service.
   Another embodiment would be for the unit to be designed to not require biosolids removal. This could be accomplished by use of organisms that have extremely low growth rates, a small amount of biosolids could exit with the effluent, or an integral digester could be used.
An Instrumentation and Control Element: Additional embodiments of the add-on unit can use different clarification elements. For example:
   The I&C element could maintain a single process parameter to control optimal growth such as redox, it may use multiple parameters to adjust growth such as redox, dissolved oxygen, and nitrite, or it may be capable of sending alarms based on sensor data
   The I&C element could have an alarm system and this system could operate locally or could communicate with non-local sources such as a web site.
      9.1.1 An Organic and Nutrient Removal System Integrated with a Septic Tank: In this Embodiment the Integrated System may Have the Following Features:
An element to separate influent wastewater that separates settleable solids, floating solids, and the remaining wastewater. This element may be separate or it may be integrated into the overall system such that multiple elements are in the same tankage.
An integrated unit that is similar to the add-on unit but is located in a separate compartment or compartments that are part of the integrated unit.
Can seed anammox into conditioning unit and the septic tank itself to act as a ‘reservoir’ in case needed)
   9.1.2 A Unit that Can be Used for Small Treatment Systems, as an Add-In for Larger Systems, or as a Sidestream Treatment System: In this Embodiment the Integrated System may Have the Following Additional Features:
Can be pre-packaged—constructed offsite and moved via truck to startup
   Can be ‘preseasoned’ with organisms
   Can seed anammox into conditioning unit (and maybe septic tank itself) to act as a ‘reservoir’ in case needed)
   Less weight involved than in trying to move a package plant with water (wastewater or mixed liquor)
Can be fully contained to precisely control oxygen in air, moisture content, etc.
Could be constructed to be placed vertically once shipped horizontally (i.e. could make an 8×8×30 foot filter and then ship it on a truck trailer to be mounted at 30-ft height
Can use pumps not only to recirculate liquid but also to add air
   Can use a mazzei injector (with valve to vary amount of air entrained—or the valve could be open/shut to add and then not add air
   Can use other forms of air injection
Liquids can be heated in the ‘sump’ to provide exact temperature regulation to obtain best growth characteristics
   Heating liquid may be more cost effective than trying to heat ventilation air
Can enclose to precisely control both air exchange and heating
Can be designed to be flooded too and used treat when submerged
   Can add aeration capability to bottom to permit treatment when submerged
   Submergence with aeration could also be used to backwash filter as necessary
Filter could be used in combination and switch between trickling filter operation and submerged operation
Can more precisely control oxygen levels both on the outer and the inner biofilms
Can be designed to remove layer of filter media to serve as a ‘seed’ for other units
If used to treat sidestream it may not require a clarifier or final filter
Use of carbon dioxide to control oxygen content and add alkalinity
   Carbon dioxide could lower the 02 content of air
   Could lower pH if necessary
   Could add alkalinity
Sodium carbonate (or bicarbonate, or sodium hydroxide) could be used to adjust the pH upward (and/or add alkalinity)
Can add mixer(s) in sump area to mix solids if necessary
   Mixer with aeration nozzles could also keep the system oxygenated when submerged
Headers could be fixed but could have valves to permit cycling to different parts of the filter if necessary
Headers could also be rotary or could travel linearly down the length of the filter
Major controls could be DO, temperature, and alkalinity
Use pumps to do mixing and add mazzei injectors to add oxygen (and maybe CO2 if needed)
   9.1.3 A Unit that can be Used Before Treatment Plants: In this Embodiment the Integrated System may Have the Following Features:
Could use a filter that can be placed in-line of high ammonia, low solids waste (such as a separated urine stream) to remove some of the ammonia
Could be similar to ‘add-on’, ‘integrated with septic tank’, and/or system for treatment plants and placed at pump stations to perform partial treatment before entering plants
   In another alternative the I&C system mantains control using only dissolved oxygen level to control the addition of aeration and this level could be set anywhere from 0 to 2.0 mg/l. The zero level is specifically called out as a alternate embodiment with an example control of stopping the aerator whenever an oxygen is detected, gradually reducing aeration unit there is no oxygen detected, and/or a combination of the two.
An instrumentation and control element to monitor and/or control the treatment process. The embodiment includes a system to monitor and control the process of the add-on unit. Monitoring includes an interface with a SCADA system to relay information to the homeowner and/or a service company. SCADA could report the status of the system, if it has power, if all equipment is working properly, high level indication, and process parameters of interest such a flow, pH, dissolve oxygen level, ammonia, nitrite, nitrate, and redox in one or more points in the system. The control system also has the ability to start and stop equipment at set times, based on a timer, and/or based on a signal from the system. An example of the latter control would be the starting and stopping (or adjustment of speed) of an aerator to maintain a set dissolved oxygen or redox level. In the embodiment all equipment is monitored for correct operation and/or failure, and air is added based on a desired redox level with more air being added to raise the redox level or less added to lower it. The target redox level would be 250 mv. Additionally, the control system can be remotely adjusted to change manner of operation. For example, if the redox probe failed or was not properly calibrated then the mode of operation could remotely be changed to add air based on a timer or the speed of the aerator (and the amount of air it pumped) could be manually adjusted.

I claim:

1. A wastewater treatment system capable of concurrent nitrification/denitrification/deammonification (NDD).

2. Where NDD in claim 1 uses attached fixed-film biofilm growth on media

3. Where the attached fixed-film biofilm in claim 2 consist of an inner biofilm contain at least some anoxic and anaerobic organisms that are shielded from detrimental levels of free oxygen by an outer coating of biofilm with at lease some aerobic organisms or other material that reduces free oxygen migrating to the inner biofilm.

4. Where the media of claim 2 is relatively stationary

5. A wastewater system using Patterned Fixed-Film Treatment (FTS) wherein treatment remains substantially uniform throughout the unit treatment process or that varies according to a prescribed pattern.

6. Where the uniform contents of claim 5 of the liquid is maintained by mixing in the range of 0.1 1.0 m/s and is sufficient for mixing but reduces shearing of biofilm and permitting some organisms to remain in suspension.

7. Where the organisms in suspension in claim 6 may have nitrifiers and aerobic denitrifiers.

8. Where the Patterned Fixed-film Treatment system of claim 5 is incorporated into a floating treatment structure.

9. A wastewater treatment system for septic tanks and other treatment units consisting of at least a conditioning unit and treatment unit or which combines the two in one unit.

10. The conditioning unit of claim 9 that adjusts wastewater by one or more of the following:
temperature, pH, alkalinity, oxygen content, flow equalization, filtering, micronutrient addition, etc..

11. The pH adjustment of claim 10 where adjustment is achieved by the dissolution of material that occurs over a period of time that extends to more than one day.

12. Where material that dissolved in claim 11 is composed of a mixture of one or more items selected from a group including calcium carbonate, magnesium carbonate, calcite, dolomite, granular limestone, crushed coral, oyster shells, and other materials commonly used to maintain a stable alkaline pH.
